(19) United States
(12) Patent Application Publication
(10) Pub. No.: US 2024/0305142 A1
(43) Pub. Date: Sep. 12, 2024

(54) POWER RECEPTION APPARATUS, WIRELESS POWER TRANSMISSION SYSTEM, CONTROL METHOD FOR CONTROLLING POWER RECEPTION APPARATUS, AND STORAGE MEDIUM

(71) Applicant: CANON KABUSHIKI KAISHA, Tokyo (JP)

(72) Inventors: TAKAHIRO SHICHINO, Tokyo (JP); WATARU TACHIWA, Kanagawa (JP)

(21) Appl. No.: 18/653,160

(22) Filed: May 2, 2024

Related U.S. Application Data
(63) Continuation of application No. PCT/JP2022/040374, filed on Oct. 28, 2022.

(30) Foreign Application Priority Data
Nov. 16, 2021 (JP) 2021-186492

(51) Int. Cl. H02J 50/80; B60L 53/10; B60L 53/66; H02J 50/60

(52) U.S. Cl. CPC H02J 50/80; H02J 50/60; B60L 53/10; B60L 53/66

(57) ABSTRACT

In a case where a power reception apparatus receives ACK or NAK as a response even though an expected response is a response indicating “not determine”, or in a case where the power reception apparatus receives a response indicating “not determine” or a response from a power transmission apparatus is an unexpected response even though an expected response is ACK or NAK as a response, the power reception apparatus transmits EPT to the power transmission apparatus, thus stopping the transmission of power from the power transmission apparatus.

### CROSS-REFERENCE TO RELATED APPLICATIONS

This application is a Continuation of International Patent Application No. PCT/JP2022/040374, filed Oct. 28, 2022, which claims the benefit of Japanese Patent Application No. 2021-186492, filed Nov. 16, 2021, both of which are hereby incorporated by reference herein in their entireties.

### BACKGROUND

### Field

The present disclosure relates to a power reception apparatus, a wireless power transmission system, a control method for controlling a power reception apparatus, and a storage medium.

### Background Art

Techniques for wireless power transmission systems have been widely developed. The Wireless Power Consortium (WPC) standard formulated as a wireless charging standard by a standards body called the WPC is widely known. A power transmission apparatus transmits power to a power reception apparatus in the range where the power transmission apparatus can transmit power based on such a standard. At this time, in this wireless power transmission system, it is important to detect the foreign object and control the transmission and reception of power with the presence of an object different from the power reception apparatus and the power transmission apparatus (such an object is hereinafter referred to as a “foreign object”) in the range where the power transmission apparatus can transmit power.

PTL 1 discusses a technique for detecting a foreign object and limiting the transmission and reception of power with the presence of the foreign object near a power transmission apparatus and a power reception apparatus compliant with the WPC standard. PTL 2 discusses a technique for short-circuiting a coil of a wireless power transmission system and performing foreign object detection. PTL 3 discusses a technique for applying a high-frequency signal to a power transmission coil of a wireless power transmission system for a certain period, measuring the high-frequency signal, and detecting a foreign object based on a change in the quality factor (Q factor) of the coil.

### CITATION LIST

### Patent Literature

PTL 1: Japanese Patent Application Laid-Open No. 2017-70074
PTL 2: Japanese Patent Application Laid-Open No. 2017-34972
PTL 3: Japanese Patent Application Laid-Open No. 2017-22999

Examples of a conceivable method for improving the accuracy of detecting a foreign object include a method for performing a Q factor measurement multiple times and determining the presence or absence of the foreign object based on results of the measurements. None of PTL 1 to 3, however, contemplates processing in a case where the presence or absence of a foreign object is determined based on a Q factor measurement performed multiple times.

### SUMMARY

In view of the above, various embodiments of the present disclosure are directed to providing an appropriate processing method in the determination of the presence or absence of an object different from a power transmission apparatus and a power reception apparatus based on a Q factor measurement performed multiple times.

According to one embodiment of the present disclosure, a power reception apparatus wirelessly receives power from a power transmission apparatus, transmits a first request to the power transmission apparatus, receives from the power transmission apparatus a response for the first request, and transmits a second request for stopping a power transfer to the power transmission apparatus based on the received response.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a wireless power transmission system according to an exemplary embodiment.

FIG. 2 is a diagram illustrating an example of an internal configuration of a power reception apparatus according to the exemplary embodiment.

FIG. 3 is a diagram illustrating an example of an internal configuration of a power transmission apparatus according to the exemplary embodiment.

FIG. 4 is a block diagram illustrating an example of a functional configuration implemented by a control unit of the power transmission apparatus.

FIG. 5 is a block diagram illustrating an example of a functional configuration implemented by a control unit of the power reception apparatus.

FIG. 6 is a diagram illustrating basic processing between the power reception apparatus and the power transmission apparatus.

FIG. 7A is a diagram illustrating processing between the power reception apparatus and the power transmission apparatus in a third foreign object detection process.

FIG. 7B is a diagram illustrating processing between the power reception apparatus and the power transmission apparatus in the third foreign object detection process.

FIG. 7C is a diagram illustrating processing between the power reception apparatus and the power transmission apparatus in the third foreign object detection process.

FIG. 7D is a diagram illustrating processing between the power reception apparatus and the power transmission apparatus in the third foreign object detection process.

FIG. 8A is a diagram illustrating processing between the power reception apparatus and the power transmission apparatus in the third foreign object detection process.

FIG. 8B is a diagram illustrating processing between the power reception apparatus and the power transmission apparatus in the third foreign object detection process.

FIG. 8C is a diagram illustrating processing between the power reception apparatus and the power transmission apparatus in the third foreign object detection process.

FIG. 9A is a diagram illustrating processing between the power reception apparatus and the power transmission apparatus in the third foreign object detection process.

FIG. 9B is a diagram illustrating processing between the power reception apparatus and the power transmission apparatus in the third foreign object detection process.

FIG. 10 is a flowchart illustrating an example of a processing procedure for solving a state mismatch with the power reception apparatus according to a first exemplary embodiment.

FIG. 11 is a flowchart illustrating an example of a processing procedure for solving a state mismatch with the power reception apparatus according to a second exemplary embodiment.

FIG. 12 is a flowchart illustrating an example of a processing procedure for solving a state mismatch with the power reception apparatus according to a third exemplary embodiment.

FIG. 13 is a flowchart illustrating an example of a processing procedure for solving a state mismatch with the power reception apparatus according to a fourth exemplary embodiment.

FIG. 14 is a flowchart illustrating an example of a processing procedure for solving a state mismatch with the power reception apparatus according to a fifth exemplary embodiment.

FIG. 15A is a diagram for illustrating an increment of the number of times M or L.

FIG. 15B is a diagram for illustrating an increment of the number of times M or L.

FIG. 15C is a diagram for illustrating an increment of the number of times M or L.

FIG. 15D is a diagram for illustrating an increment of the number of times M or L.

FIG. 16 is a flowchart illustrating an example of a processing procedure of the power transmission apparatus in a case where the power transmission apparatus receives a packet that stores information regarding the number of times M of receptions of responses according to the fourth exemplary embodiment.

FIG. 17 is a flowchart illustrating an example of a processing procedure of the power transmission apparatus in a case where the power transmission apparatus receives a packet that stores a RES bit according to the fourth exemplary embodiment.

FIG. 18 is a flowchart illustrating an example of a processing procedure of the power transmission apparatus in a case where the power transmission apparatus receives a received power packet according to the fifth exemplary embodiment.

FIG. 19 is a diagram illustrating a format of a received power packet in the Wireless Power Consortium (WPC) standard.

FIG. 20A is a conceptual diagram illustrating a method for measuring a Q factor in a time domain.

FIG. 20B is a conceptual diagram illustrating a method for measuring a Q factor in a time domain.

FIG. 21 is a diagram illustrating a foreign object detection method with a power loss technique.

### DESCRIPTION OF THE EMBODIMENTS

With reference to the accompanying drawings, a first exemplary embodiment of the present disclosure will be described in detail below.

### (Configuration of System)

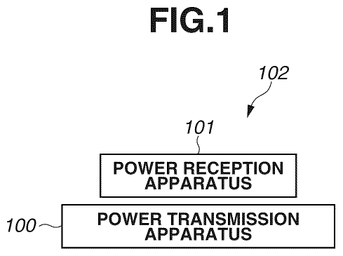

FIG. 1 is a diagram illustrating an example of the configuration of a wireless power transmission system 102 according to the present exemplary embodiment. The wireless power transmission system 102 according to the present exemplary embodiment includes, for example, a power transmission apparatus 100 and a power reception apparatus 101 as illustrated in FIG. 1. The power transmission apparatus 100 and the power reception apparatus 101 are compliant with the Wireless Power Consortium (WPC) standard.

The power transmission apparatus 100 is, for example, an electronic device that wirelessly transmits electric power to the power reception apparatus 101 placed on the power transmission apparatus 100. The power transmission apparatus 100 wirelessly transmits electric power to the power reception apparatus 101 via a power transmission coil. The power reception apparatus 101 is, for example, an electronic device that receives electric power from the power transmission apparatus 100 and charges a built-in battery.

In the wireless power transmission system 102 according to the present exemplary embodiment, wireless electric power transmission with an electromagnetic induction method for wireless charging is performed based on the WPC standard. Specifically, the power transmission apparatus 100 and the power reception apparatus 101 perform wireless power transmission for wireless charging based on the WPC standard between a power transmission antenna of the power transmission apparatus 100 and a power reception antenna of the power reception apparatus 101. In the wireless power transmission system 102 according to the present exemplary embodiment, a method defined by the WPC standard is used as the method for the wireless power transmission. The method for the wireless electric power transmission, however, is not limited to this, and other methods may be used. For example, an electromagnetic induction method, a magnetic field resonance method, an electric field resonance method, a microwave method, or a method using a laser may be used. Although the wireless power transmission is used for wireless charging in the present exemplary embodiment, the wireless power transmission may be performed for use other than wireless charging.

### (Configurations of Apparatuses)

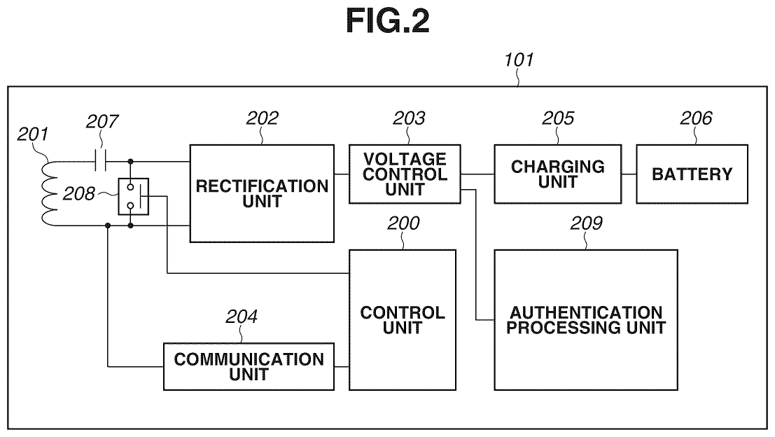

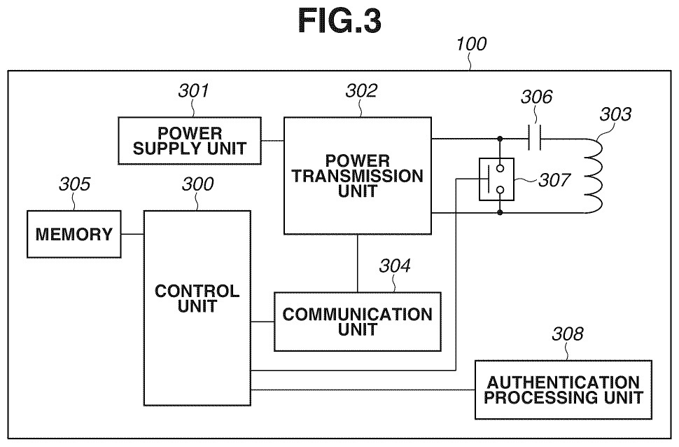

FIG. 2 is a diagram illustrating an example of the internal configuration of the power reception apparatus 101 according to the present exemplary embodiment. FIG. 3 is a diagram illustrating an example of the internal configuration of the power transmission apparatus 100 according to the present exemplary embodiment. For example, the power reception apparatus 101 includes a control unit 200, a power reception coil 201, a rectification unit 202, a voltage control unit 203, a communication unit 204, a charging unit 205, a battery 206, a resonance capacitor 207, and a switch 208.

The control unit 200 controls the entirety of the power reception apparatus 101. The control unit 200 includes one or more processors such as a central processing unit (CPU) and a microprocessor unit (MPU). The control unit 200 may include one or more storage devices such as a random-access memory (RAM) and a read-only memory (ROM). The control unit 200 causes, for example, the processors to execute programs stored in the storage devices to execute processes described below.

The power reception coil 201 is used to receive power from a power transmission coil 303 of the power transmission apparatus 100. The rectification unit 202 converts an alternating-current voltage and an alternating current of the power received via the power reception coil 201 into a direct-current voltage and a direct current, respectively. The voltage control unit 203 converts the level of the direct-current voltage input from the rectification unit 202 into the level of a direct-current voltage suitable (neither too high nor too low) for the operations of the control unit 200 and the charging unit 205. The voltage control unit 203 also supplies the direct-current voltage at the converted level to the charging unit 205. The charging unit 205 charges the battery 206 with the direct-current voltage supplied from the voltage control unit 203. The communication unit 204 performs control communication for wireless charging based on the WPC standard with the power transmission apparatus 100. This control communication is performed by performing load modulation on the alternating-current voltage and the alternating current with which the power is received by the power reception coil 201.

The power reception coil 201 is connected to the resonance capacitor 207 and configured to resonate at a particular frequency F2. The switch 208 is a switch for short-circuiting the power reception coil 201 and the resonance capacitor 207 and is controlled by the control unit 200. If the switch 208 is turned on, the power reception coil 201 and the resonance capacitor 207 form a series resonance circuit. At this time, a current flows through only the power reception coil 201, the resonance capacitor 207, and the closed circuit of the switch 208, and a current does not flow through the rectification unit 202 and the voltage control unit 203. In contrast, if the switch 208 is turned off, a current flows through the rectification unit 202 and the voltage control unit 203 via the power reception coil 201 and the resonance capacitor 207.

Next, the details of the internal configuration of the power transmission apparatus 100 are described. For example, the power transmission apparatus 100 includes a control unit 300, a power supply unit 301, a power transmission unit 302, a power transmission coil 303, a communication unit 304, a memory 305, a resonance capacitor 306, and a switch 307.

The control unit 300 controls the entirety of the power transmission apparatus 100. The control unit 300 includes one or more processors such as a CPU and an MPU. The control unit 300 causes, for example, the processors to execute programs stored in the memory 305 and a storage device in the control unit 300 to execute processes described below. The power supply unit 301 supplies power to the functional blocks. For example, the power supply unit 301 is mains electricity or a battery. For example, the battery stores power supplied from mains electricity.

The power transmission unit 302 converts direct-current power or alternating-current power input from the power supply unit 301 into alternating-current power in a frequency range for use in wireless power transmission and inputs the alternating-current power to the power transmission coil 303. Thus, the power transmission unit 302 causes the power transmission coil 303 to generate an electromagnetic wave for causing the power reception apparatus 101 to receive power. For example, the power transmission unit 302 causes a switching circuit having a half-bridge or full-bridge configuration with a field-effect transistor (FET) to convert a direct-current voltage supplied from the power supply unit 301 into an alternating-current voltage. In this case, the power transmission unit 302 includes a gate driver that controls the turning on and off of the FET.

The power transmission unit 302 also adjusts at least one of a voltage (a power transmission voltage) and a current (a power transmission current) to be output to the power transmission coil 303 or a frequency, thus controlling the intensity or the frequency of the electromagnetic wave to be output. For example, the power transmission unit 302 strengthens the intensity of the electromagnetic wave by increasing the power transmission voltage or the power transmission current and weakens the intensity of the electromagnetic wave by decreasing the power transmission voltage or the power transmission current. The power transmission unit 302 has the capability to supply power for outputting a power of at least 15 watts (W) to the charging unit 205 of the power reception apparatus 101 compatible with the WPC standard. Based on an instruction from the control unit 300, the power transmission unit 302 also controls the output of the alternating-current power to start or stop the output of the electromagnetic wave from the power transmission coil 303.

The communication unit 304 performs communication for power transmission control based on the WPC standard with the power reception apparatus 101 via the power transmission coil 303. The communication unit 304 modulates an alternating-current voltage and an alternating current output from the power transmission unit 302 using frequency modulation (frequency shift keying (FSK)) and transmits information to the power reception apparatus 101. The communication unit 304 also demodulates an alternating-current voltage and an alternating current modulated using load modulation by the communication unit 204 of the power reception apparatus 101, to acquire information transmitted from the power reception apparatus 101. That is, the communication unit 304 superimposes information to be transmitted to the power reception apparatus 101 onto an electromagnetic wave with which power is transmitted from the power transmission unit 302, and detects a reception signal superimposed on the electromagnetic wave by the power reception apparatus 101, to communicate with the power reception apparatus 101. The communication unit 304 may communicate with the power reception apparatus 101 in accordance with a standard different from the WPC standard by using a coil (or an antenna) different from the power transmission coil 303. The communication unit 304 may also communicate with the power reception apparatus 101 by selectively using a plurality of communication functions.

For example, the memory 305 stores a control program to be executed by the control unit 300 and information regarding the states of the power transmission apparatus 100 and the power reception apparatus 101. For example, the state of the power transmission apparatus 100 is acquired by the control unit 300. The state of the power reception apparatus 101 is acquired by the control unit 200 of the power reception apparatus 101 and transmitted from the communication unit 204. The power transmission apparatus 100 acquires information indicating the state via the communication unit 304.

The power transmission coil 303 is connected to the resonance capacitor 306 and configured to resonate at a particular frequency F1. The switch 307 is used for short-circuiting the power transmission coil 303 and the resonance capacitor 306 and is controlled by the control unit 300. If the switch 307 is turned on, the power transmission coil 303 and the resonance capacitor 306 form a series resonance circuit. At this time, a current flows through only the power transmission coil 303, the resonance capacitor 306, and the closed circuit of the switch 307. If the switch 307 is turned off, power is supplied to the power transmission coil 303 and the resonance capacitor 306 from the power transmission unit 302.

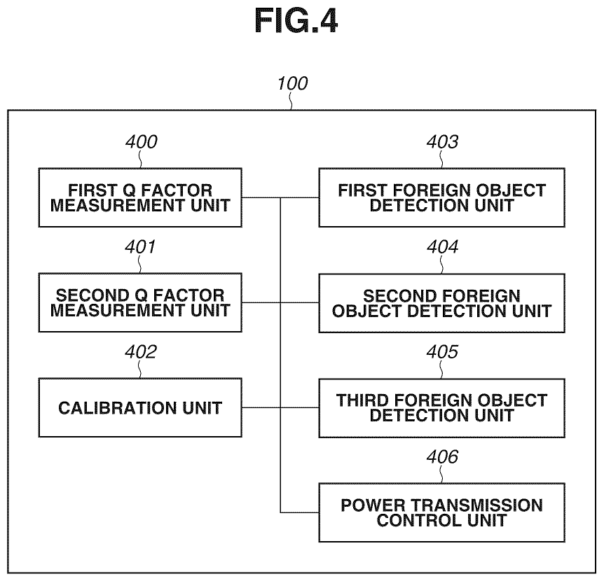

FIG. 4 is a block diagram illustrating an example of a functional configuration achieved by the control unit 300 of the power transmission apparatus 100. The control unit 300 operates as functional units such as a first quality (Q) factor measurement unit 400, a second Q factor measurement unit 401, a calibration unit 402, a first foreign object detection unit 403, a second foreign object detection unit 404, a third foreign object detection unit 405, and a power transmission control unit 406. In the following description, an object included in the range where the power transmission apparatus 100 can transmit power and different from the power transmission apparatus 100 and the power reception apparatus 101 will be referred to as a “foreign object”.

The first Q factor measurement unit 400 measures a Q factor in a frequency domain (a first Q factor measurement) as described below. The second Q factor measurement unit 401 measures a Q factor in a time domain (a second Q factor measurement) as described below. The calibration unit 402 performs the process of acquiring calibration data points and creating a calibration curve as described below.

The first foreign object detection unit 403 executes a foreign object detection process based on a first Q factor measured by the first Q factor measurement unit 400 (a first foreign object detection process). The second foreign object detection unit 404 executes a foreign object detection process based on a power loss technique (a second foreign object detection process). The third foreign object detection unit 405 executes a foreign object detection process based on a second Q factor measured by the second Q factor measurement unit 401 (a third foreign object detection process). The power transmission control unit 406 performs processing regarding the start of the transmission of power, the stop of the transmission of power, an increase or decrease in the transmission power of the power transmission unit 302. The functional units illustrated in FIG. 4 are configured as independent programs and operate in parallel while synchronizing the programs through event processing.

### (Foreign Object Detection Methods in WPC Standard)

Next, foreign object detection methods defined by the WPC standard are described using the power transmission apparatus 100 and the power reception apparatus 101. As the foreign object detection methods in the WPC standard, a foreign object detection method based on a Q factor measured in a frequency domain (a first foreign object detection method) and a foreign object detection method based on a power loss technique (a second foreign object detection method) are described.

### (1) Foreign Object Detection Method Based on Q Factor Measured in Frequency Domain

### (First Foreign Object Detection Method)

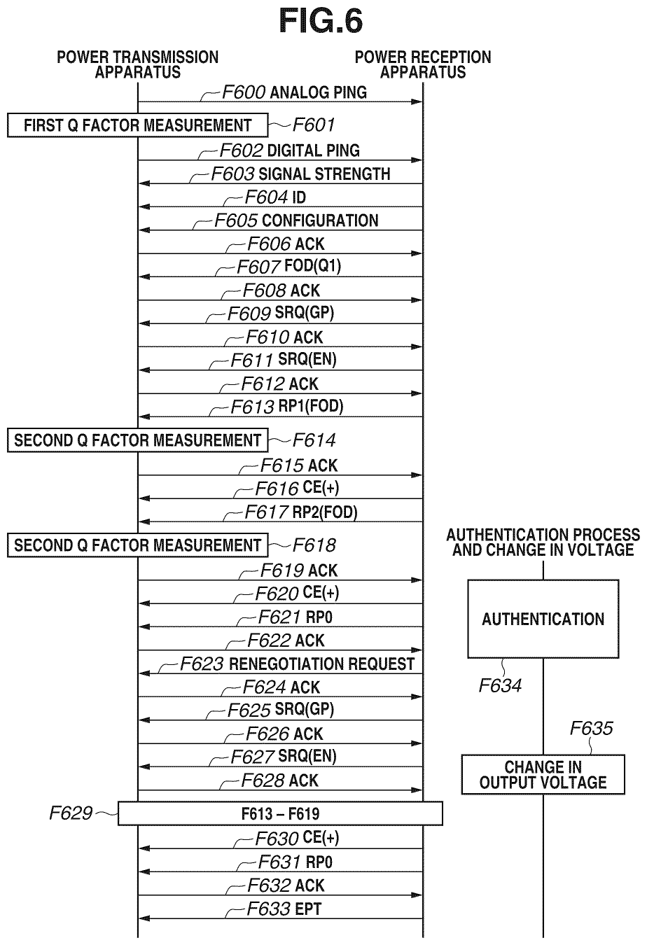

In the first foreign object detection method, initially, the power transmission apparatus 100 measures a Q factor that changes under the influence of the foreign object in a frequency domain (the first Q factor measurement). This measurement is executed during the period from when the power transmission apparatus 100 transmits an analog ping to when the power transmission apparatus 100 transmits a digital ping (see F601 in FIG. 6).

For example, to measure the Q factor, the power transmission unit 302 sweeps the frequency of wireless power output from the power transmission coil 303, and the first Q factor measurement unit 400 measures the voltage value of the end of the resonance capacitor 306 connected in series (or in parallel) to the power transmission coil 303. The first Q factor measurement unit 400 then searches for a resonance frequency at which the voltage value reaches a peak. Subsequently, the first Q factor measurement unit 400 calculates the Q factor of the power transmission coil 303 from a frequency indicating a voltage value 3 dB lower than the voltage value at the peak measured at the resonance frequency, and the resonance frequency.

The Q factor may be measured using another method. For example, the power transmission unit 302 sweeps the frequency of wireless power output from the power transmission coil 303, and the first Q factor measurement unit 400 measures the voltage value of the end of the resonance capacitor 306 connected in series to the power transmission coil 303 and searches for a resonance frequency at which the voltage value reaches a peak. The first Q factor measurement unit 400 then measures voltage values at both ends of the resonance capacitor 306 at the resonance frequency and calculates the Q factor of the power transmission coil 303 from the ratio between the voltage values at both ends.

After the Q factor of the power transmission coil 303 is calculated, the first foreign object detection unit 403 of the power transmission apparatus 100 acquires a Q factor serving as a determination criterion for foreign object detection from the power reception apparatus 101 via the communication unit 304. For example, the first foreign object detection unit 403 receives from the power reception apparatus 101 the Q factor of a certain power transmission coil defined by the WPC standard in a case where the power reception apparatus 101 is placed on the power transmission coil (see F607 in FIG. 6). This Q factor is stored in a foreign object detection (FOD) status packet to be transmitted from the power reception apparatus 101, and the power transmission apparatus 100 acquires the Q factor by receiving the FOD status packet.

The first foreign object detection unit 403 estimates, from the acquired Q factor, the Q factor of the power transmission coil 303 in a case where the power reception apparatus 101 is placed on the power transmission apparatus 100. In the present exemplary embodiment, the estimated Q factor is referred to as a “first reference Q factor”. The Q factor to be stored in the FOD status packet is stored in advance in a non-volatile memory (not illustrated) of the power reception apparatus 101. That is, the power reception apparatus 101 notifies the power transmission apparatus 100 of the Q factor stored in advance. The Q factor corresponds to Q1.

The first foreign object detection unit 403 of the power transmission apparatus 100 compares the first reference Q factor and the Q factor measured by the first Q factor measurement unit 400 and determines the presence or absence of the foreign object based on the comparison result. For example, a Q factor a % lower than the first reference Q factor is set to a threshold, and if the measured Q factor is lower than the threshold, the first foreign object detection unit 403 determines that there is a high possibility that the foreign object is present. If not, the first foreign object detection unit 403 determines that there is a high possibility that the foreign object is absent.

### (2) Foreign Object Detection Method Based on Power Loss Technique (Second Foreign Object Detection Method)

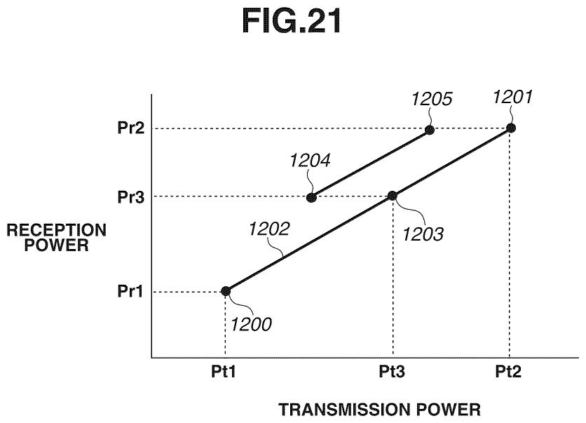

Next, with reference to FIG. 21, the foreign object detection method based on the power loss technique defined by the WPC standard is described. FIG. 21 is a diagram illustrating the foreign object detection method using the power loss technique. The horizontal axis represents the transmission power of the power transmission apparatus 100. The vertical axis represents the reception power of the power reception apparatus 101. The transmission power of the power transmission unit 302 of the power transmission apparatus 100 is controlled by the power transmission control unit 406.

The power transmission unit 302 of the power transmission apparatus 100 initially transmits a digital ping to the power reception apparatus 101. The communication unit 304 of the power transmission apparatus 100 then receives a reception power value Pr1 (referred to as a “light load”) of the power reception apparatus 101 using a received power packet (a mode 1). Hereinafter, the received power packet (the mode 1) will be referred to as “RP1”. The reception power value Pr1 is a reception power value in a case where the power reception apparatus 101 does not supply the received power to a load (the charging unit 205 and the battery 206). The control unit 300 of the power transmission apparatus 100 stores in the memory 305 the relationship (a point 1200 in FIG. 21) between the received reception power value Pr1 and a transmission power value Pt1 when the reception power value Pr1 is obtained. This enables the power transmission apparatus 100 to recognize that the amount of power loss between the power transmission apparatus 100 and the power reception apparatus 101 when the power is transmitted with the transmission power value Pt1 is Pt1−Pr1 (Pₗₒₛₛ1).

Next, the communication unit 304 of the power transmission apparatus 100 receives the value of a reception power value Pr2 (referred to as a “connected load”) of the power reception apparatus 101 from the power reception apparatus 101 using a received power packet (a mode 2). Hereinafter, the received power packet (the mode 2) will be referred to as “RP2”. Pr2 is a reception power value in a case where the power reception apparatus 101 supplies the received power to the load. the power transmission apparatus 100 then stores in the memory 305 the relationship (a point 1201 in FIG. 21) between the received reception power value Pr2 and a transmission power value Pt2 when the reception power value Pr2 is obtained. This enables the power transmission apparatus 100 to recognize that the amount of power loss between the power transmission apparatus 100 and the power reception apparatus 101 when the power is transmitted with the transmission power value Pt2 is Pt2−Pr2 (Pₗₒₛₛ2).

The calibration unit 402 of the power transmission apparatus 100 then linearly interpolates the points 1200 and 1201 to create a straight line 1202. The straight line 1202 corresponds to the relationship between the transmission power and the reception power in the state where the foreign object is absent on the periphery of the power transmission apparatus 100 and the power reception apparatus 101. Thus, based on the transmission power value and the straight line 1202, the power transmission apparatus 100 can predict the reception power value in the state where there is a high possibility that the foreign object is absent. For example, for the transmission power value of Pt3, the power transmission apparatus 100 can predict a reception power value Pr3 based on a point 1203 on the straight line 1202 corresponding to a case where the transmission power value is Pt3.

Suppose that the communication unit 304 receives a reception power value Pr3′ from the power reception apparatus 101 in a case where the power transmission unit 302 of the power transmission apparatus 100 transmits power with the transmission power value Pt3 to the power reception apparatus 101. The second foreign object detection unit 404 of the power transmission apparatus 100 calculates a value Pr3-Pr3′ (=Pₗₒₛₛ_FO) obtained by subtracting the reception power value Pr3′ actually received from the power reception apparatus 101 from the reception power value Pr3 in the state where the foreign object is absent. The power value Pₗₒₛₛ_FO can be regarded as the amount of power loss that would be consumed by the foreign object if the foreign object were present between the power transmission apparatus 100 and the power reception apparatus 101. Thus, if the power value Pₗₒₛₛ_FO that would be consumed by the foreign object exceeds a threshold determined in advance, the second foreign object detection unit 404 can determine that the foreign object is present. For example, this threshold is derived based on the relationship between the points 1200 and 1201.

The second foreign object detection unit 404 of the power transmission apparatus 100 also obtains in advance the amount of power loss Pt3−Pr3 (=Pₗₒₛₛ3) between the power transmission apparatus 100 and the power reception apparatus 101 from the reception power value Pr3 in the state where the foreign object is absent. The second foreign object detection unit 404 then calculates the amount of power loss Pt3−Pr3′ (=Pₗₒₛₛ3′) between the power transmission apparatus 100 and the power reception apparatus 101 in the state where the foreign object is present based on the reception power value Pr3′ received from the power reception apparatus 101 in the state where the presence of the foreign object is unknown. Then, the second foreign object detection unit 404 calculates Pₗₒₛₛ3′−Pₗₒₛₛ3. If this value exceeds a threshold determined in advance, the second foreign object detection unit 404 can determine that the foreign object is present. Pₗₒₛₛ3′−Pₗₒₛₛ3=Pt3−Pr3′−Pt3+Pr3=Pr3−Pr3′. Thus, comparison between the amounts of power loss enables estimation of the power Pₗₒₛₛ_FO that is estimated to have been consumed by the foreign object.

As described above, the power value Pₗₒₛₛ_FO that would be consumed by the foreign object may be calculated as the difference in reception power Pr3−Pr3′, or may be calculated as the difference in power loss Pₗₒₛₛ3′−Pₗₒₛₛ3 (=Pₗₒₛₛ_FO).

After the straight line 1202 is acquired by the calibration unit 402, the second foreign object detection unit 404 of the power transmission apparatus 100 periodically receives the current reception power value (e.g., the reception power value Pr3′) from the power reception apparatus 101 via the communication unit 304. The current reception power value periodically transmitted from the power reception apparatus 101 is transmitted as a received power packet (a mode 0) to the power transmission apparatus 100. The second foreign object detection unit 404 of the power transmission apparatus 100 performs foreign object detection based on the reception power value stored in the received power packet (the mode 0) and the straight line 1202. Hereinafter, the received power packet (the mode 0) will be referred to as “RP0”. The reception power value stored in the received power packet (RP1, RP2, or RP0) will be referred to as “calibration data”.

In the present exemplary embodiment, the points 1200 and 1201 for acquiring the straight line 1202 in the state where the foreign object is absent on the periphery of the power transmission apparatus 100 and the power reception apparatus 101 are referred to as “calibration data points”. A line segment (the straight line 1202) acquired by interpolating at least two calibration data points is referred to as a “calibration curve”. The calibration data points and the calibration curve are used for the foreign object detection process performed by the second foreign object detection unit 404.

### (3) Foreign Object Detection Method Based on Q Factor Measured in Time Domain (Third Foreign Object Detection Method)

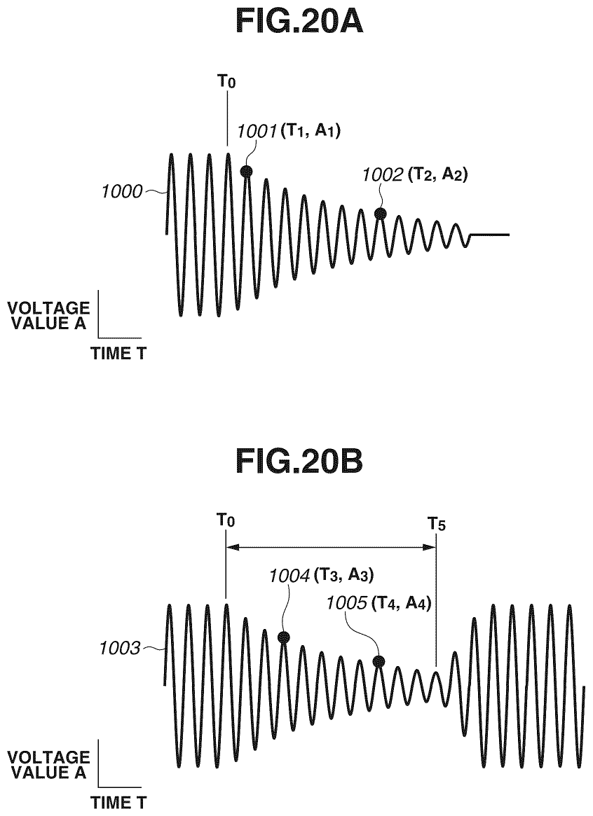

While the foreign object detection methods in the WPC standard are as described above, a different method is also possible regarding the measurement of a Q factor. Next, with reference to FIGS. 20A and 20B, a third foreign object detection method is described.

Each of FIGS. 20A and 20B is a conceptual diagram for illustrating a method for measuring a Q factor in a time domain (the second Q factor measurement). In the present exemplary embodiment, a foreign object detection method based on a second Q factor is referred to as a “third foreign object detection method”. The second Q factor measurement is performed by the second Q factor measurement unit 401. The power transmission control unit 406 controls the transmission power of the power transmission unit 302 of the power transmission apparatus 100. In the second Q factor measurement, the power transmission apparatus 100 and the power reception apparatus 101 turn on switches during the same period, to temporarily interrupt the transmission of power, and then prevents the received power from being delivered to the load. This exponentially decreases, for example, the voltage applied to the coil. The second Q factor is then calculated based on the manner of the decrease.

A waveform 1100 in FIG. 20A indicates the lapse of time of the value of a high-frequency voltage to be applied to the power transmission coil 303 or the end of the resonance capacitor 306 of the power transmission apparatus 100 (hereinafter referred to simply as “the voltage value of the power transmission coil”). The horizontal axis represents time, and the vertical axis represents the voltage value. At a time T0, the application of the high-frequency voltage (the transmission of power) is stopped. A point 1101 is a single point (in other words, a single local maximum point) on the envelope of the high-frequency voltage and indicates the high-frequency voltage at a time T₁. (T₁, A₁) in FIG. 20A indicates that the voltage value at the time T₁ is A₁. Similarly, a point 1102 is a single point on the envelope of the high-frequency voltage and indicates the high-frequency voltage at a time T₂. (T₂, A₂) in FIG. 20A indicates that the voltage value at the time T₂ is A₂.

The second Q factor measurement is executed based on a change over time in the voltage value at and after the time T0. For example, the Q factor is calculated using the following Equation 1 based on the time between the points 1101 and 1102 on the envelope of the voltage value, the voltage value, and a frequency f of the high-frequency voltage (hereinafter, f will be referred to as an “operating frequency”).

$$Q = π f ( {T}_{2} - {T}_{1} ) / ln ( {A}_{1} / {A}_{2} ) \qquad ( Equation 1 )$$

In other words, the Q factor in Equation is an electrical characteristic determined based on the relationship between the elapsed time of the power transmission coil 303 and the amount of decrease in the voltage at this time after the transmission of power is limited (stopped) for a predetermined period.

Next, with reference to FIG. 20B, a description is given of processing for the power transmission apparatus 100 to measure the Q factor in the time domain in the present exemplary embodiment. A waveform 1103 indicates the value of a high-frequency voltage to be applied to the power transmission coil 303, and the frequency of the high-frequency voltage is a frequency between 100 kHz and 148.5 kHz, which is used in the Qi standard. Points 1104 and 1105 are parts of the envelope of the voltage value.

In a section from a time T₀ to a time T₅, the power transmission unit 302 of the power transmission apparatus 100 stops the transmission of power. The second Q factor measurement unit 401 of the power transmission apparatus 100 measures the Q factor based on Equation from a voltage value A₃ (the point 1104) at a time T₃, a voltage value A₄ (the point 1105) at a time T₄, and the operating frequency of the high-frequency voltage. The power transmission unit 302 of the power transmission apparatus 100 resumes the transmission of power at the time T₅. Thus, the second Q factor measurement is performed by the power transmission apparatus 100 temporarily interrupting the transmission of power and measuring the Q factor based on the lapse of time, the voltage value, and the operating frequency. Also in the power reception apparatus 101, similarly, the second Q factor is measured as an electrical characteristic determined based on the relationship between the elapsed time of the power reception coil 201 and the amount of decrease in the voltage at this time after the transmission of power is limited (stopped). In the present exemplary embodiment, the method for thus measuring the Q factor in the time domain is referred to as “a Q factor measurement method using a waveform attenuation method”.

The third foreign object detection unit 405 of the power transmission apparatus 100 also compares the first reference Q factor and the Q factor measured by the second Q factor measurement unit 401 and determines the presence or absence of the foreign object based on the comparison result. For example, with a Q factor a % lower than the first reference Q factor serving as a threshold, if the measured Q factor is lower than the threshold, the third foreign object detection unit 405 determines that there is a high possibility that the foreign object is present. If not, the third foreign object detection unit 405 determines that there is a high possibility that the foreign object is absent.

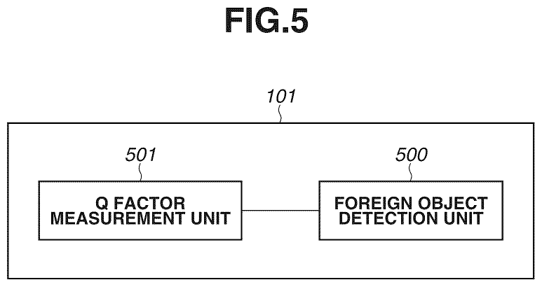

Although the Q factor measurement method using the waveform attenuation method is performed by the power transmission apparatus 100 in the above description, this is not restrictive. A configuration may be employed in which the Q factor measurement method based on the waveform attenuation method is performed by the power reception apparatus 101. FIG. 5 is a block diagram illustrating an example of a functional configuration achieved by the control unit 200 of the power reception apparatus 101. The control unit 200 operates as functional units by executing programs. A Q factor measurement unit 501 measures a Q factor in a time domain (the second Q factor measurement). A foreign object detection unit 500 executes a foreign object detection process based on a second Q factor measured by the Q factor measurement unit 501 (a third foreign object detection process). The processing units in FIG. 5 are configured as independent programs and operate in parallel while synchronizing the programs through event processing. As described above, the power reception apparatus 101 may have a configuration as illustrated in FIG. 5, and the Q factor measurement unit 501 of the power reception apparatus 101 may perform the third foreign object detection process.

In the above waveform attenuation method, the Q factor is measured based on the relationship between the elapsed time of the power transmission coil 303 and the amount of decrease in the voltage at this time after the transmission of power is limited (stopped) for the predetermined period, but this is not restrictive. For example, the Q factor can also be measured based on the relationship between the elapsed time of the power transmission coil 303 and the amount of decrease in the current at this time after the transmission of power is limited (stopped) for the predetermined period. That is, the third foreign object detection process is a method for performing foreign object detection using the Q factor measured based on the value of the voltage or the current at at least two times in the predetermined period when the transmission of power is limited.

### (Basic Operations of Power Transmission Apparatus and Power Reception Apparatus)

Next, with reference to FIG. 6, a description is provided of examples of the operations in a case where the third foreign object detection process is applied to a process compliant with the WPC standard.

In F600, the power transmission apparatus 100 transmits an analog ping to detect an object present near the power transmission coil 303. The analog ping is pulsed power and is used for detecting an object. Even if the power reception apparatus 101 receives the analog ping, the received power is too small to start the control unit 200. The power transmission apparatus 100 detects an object using the analog ping based on a shift in the resonance frequency of the voltage value inside the power transmission coil 303 due to the object present near the power transmission coil 303 or a change in the voltage value of the voltage flowing through the power transmission coil 303 or the current value of the current flowing through the power transmission coil 303.

In F601, if the power transmission apparatus 100 detects an object using the analog ping, the power transmission apparatus 100 measures the Q factor of the power transmission coil 303 through the first Q factor measurement. In F602, the power transmission apparatus 100 starts transmitting a digital ping after the first Q factor measurement. The digital ping is power for starting the control unit 200 of the power reception apparatus 101 and is power greater than the analog ping. From this point onward, power is continuously transmitted with the digital ping. That is, from when the power transmission apparatus 100 starts transmitting the digital ping to when the power transmission apparatus 100 receives an end power transfer (EPT) packet from the power reception apparatus 101 (F633), the power transmission apparatus 100 continues to transmit power greater than the digital ping.

In F603, if the control unit 200 receives the digital ping and starts, the power reception apparatus 101 stores in a signal strength packet the voltage value of the received digital ping, and transmits the signal strength packet to the power transmission apparatus 100. Next, in F604, the power reception apparatus 101 transmits to the power transmission apparatus 100 an identification (ID) packet that stores version information regarding the WPC standard with which the power reception apparatus 101 is compliant and ID including device identification information. In F605, the power reception apparatus 101 transmits to the power transmission apparatus 100 a configuration packet including information indicating a maximum value of power to be supplied from the voltage control unit 203 to the load (the charging unit 205). The power reception apparatus 101 according to the present exemplary embodiment has the capability to supply a power of up to 15 watts to the load.

As described above, the power transmission apparatus 100 receives the ID packet and the configuration packet. In F606, if the power transmission apparatus 100 determines that the power reception apparatus 101 is compatible with an expansion protocol of the WPC standard v1.2 or later (including the negotiation described below), the power transmission apparatus 100 responds with ACK (a positive response).

If the power reception apparatus 101 receives the ACK, a transition is made to the negotiation phase where a negotiation on power to be transmitted and received is made. In F607, the power reception apparatus 101 initially transmits an FOD status packet to the power transmission apparatus 100. In the present exemplary embodiment, the FOD status packet transmitted in F607 is referred to as “FOD (Q1)”. The power transmission apparatus 100 performs foreign object detection with the first foreign object detection method based on the Q factor stored in the received FOD (Q1) and the Q factor measured through the first Q factor measurement. In F608, if the power transmission apparatus 100 determines that there is a high possibility that the foreign object is absent, the power transmission apparatus 100 transmits ACK indicating a result of the determination to the power reception apparatus 101.

In response to receiving the ACK, the power reception apparatus 101 negotiates about guaranteed power (GP) that is a maximum value of power requested by the power reception apparatus 101. The GP indicates the load power of the power reception apparatus 101 (power consumed by the battery 206) agreed on with the power transmission apparatus 100. In F609, this negotiation is realized by the power reception apparatus 101 transmitting to the power transmission apparatus 100 a packet that stores the value of the GP requested by the power reception apparatus 101 in a specific request defined by the WPC standard. In the present exemplary embodiment, this packet is referred to as “SRQ (GP)”.

The power transmission apparatus 100 responds to the SRQ (GP) based on the power transmission capability of the power transmission apparatus 100. In F610, if the power transmission apparatus 100 determines that the GP is acceptable, the power transmission apparatus 100 transmits ACK indicating that the request is accepted. In the present exemplary embodiment, suppose that the power reception apparatus 101 fails to check the validity of the power transmission apparatus 100 through the authentication described below and therefore the power reception apparatus 101 requests not 15 watts but 5 watts as the GP using the SRQ (GP). In F611, if the negotiation about a plurality of parameters including the GP is completed, the power reception apparatus 101 transmits “SRQ (EN)” for requesting the end of the negotiation (end negotiation), among specific requests, to the power transmission apparatus. In F612, the power transmission apparatus 100 transmits ACK in response to the SRQ (EN), ends the negotiation phase, and a transition is made to the power transfer phase where power defined by the GP is transmitted and received.

Next, the power transmission apparatus 100 creates a calibration curve for executing the foreign object detection method based on the above-described power loss technique (the second foreign object detection method). A case is now described where the third foreign object detection is performed. A reserved area of a received power packet transmitted from the power reception apparatus 101 includes an information element that requests the power transmission apparatus 100 to execute the second Q factor measurement. For example, a 1-bit field indicating whether to request the second Q factor measurement is provided in the reserved area. Then, if the second Q factor measurement is to be requested, the power reception apparatus 101 stores “1” in the bit. If the second Q factor measurement is not to be requested, the power reception apparatus 101 stores “0” in the bit. In the present exemplary embodiment, this bit is referred to as a “request bit”. In the present exemplary embodiment, RP1 in which “1” is stored in the request bit is represented as “RP1 (FOD)”. As illustrated in FIG. 6, in F613, the power reception apparatus 101 transmits RP1 (FOD) to the power transmission apparatus 100.

If the power transmission apparatus 100 receives the RP1 (FOD), then in F614, the power transmission apparatus 100 performs the second Q factor measurement. The power transmission apparatus 100 determines responses to the RP1 and RP2 described below based on the following three pieces of information. The first information is information regarding whether the transmission power value within the period of a period T_{window} that ends a time T_{offset} before the beginning of the received power packet is received is stable (it may also be said that a change in the transmission power value is less than or equal to a particular threshold). The second information is information regarding whether an integer stored in a control error packet (CE) is smaller than a particular value. The third information is the result of the third foreign object detection process. Suppose that the transmission power value is stable, and the power transmission apparatus 100 determines based on the third foreign object detection that there is a high possibility that the foreign object is absent. In this case, the power transmission apparatus 100 determines that the reception power value stored in the RP1 (FOD) and the transmission power value of the power transmission apparatus 100 when the reception power is obtained are accepted as a calibration data point (corresponding to the point 1200 in FIG. 21). In F615, the power transmission apparatus 100 transmits ACK to the power reception apparatus 101.

Next, in F616, the power reception apparatus 101 transmits CE (+) for making a request to increase the power reception voltage (or the power reception current or the reception power) to the power transmission apparatus 100. The CE stores an integer with a sign “+” if a request is to be made to increase the power reception voltage. The CE stores an integer with a sign “−” if a request is to be made to decrease the power reception voltage. The CE stores “0” if the current power reception voltage is to be maintained. In the present exemplary embodiment, the CE that stores an integer with the sign “+” is referred to as “CE (+)”. The CE that stores an integer with the sign “−” is referred to as “CE (−)”. The CE that stores “0” is referred to as “CE (0)”. On the other hand, based on the sign and the integer stored in the CE, the power transmission apparatus 100 quickly controls the transmission of power. Specifically, if an integer with the sign “+” is stored, the power transmission apparatus 100 quickly increases the power transmission voltage. If an integer with the sign “−” is stored, the power transmission apparatus 100 quickly decreases the power transmission voltage. If “O” is stored, the power transmission apparatus 100 maintains the power transmission voltage. If the power transmission apparatus 100 receives the CE (+), the power transmission apparatus 100 increases the transmission power by changing the setting value of the power transmission unit 302. If the reception power increases in response to the CE (+), the power reception apparatus 101 supplies the received power to the load (the charging unit 205 and the battery 206).

Next, in F617, the power reception apparatus 101 transmits RP2 (FOD) in which “1” is stored in the request bit to the power transmission apparatus 100. In F618, the power transmission apparatus 100 performs the second Q factor measurement according to the request for the second Q factor measurement. The power transmission apparatus 100 determines based on the third foreign object detection that there is a high possibility that the foreign object is absent. Also in this case, the power transmission apparatus 100 determines that the reception power value stored in the RP2 (FOD) and the transmission power value of the power transmission apparatus 100 when the reception power is obtained are accepted as a calibration data point (corresponding to the point 1201 in FIG. 21). In F619, the power transmission apparatus 100 transmits ACK to the power reception apparatus 101.

Next, in F620, the power reception apparatus 101 transmits CE (+) to the power transmission apparatus 100. Then, if the power transmission apparatus 100 receives the CE (+), the power transmission apparatus 100 changes the setting value of the power transmission unit 302, thus increasing the transmission power.

Next, in F621, the power reception apparatus 101 transmits RP0 in which “O” is stored in the request bit to the power transmission apparatus 100. If the power transmission apparatus 100 receives the RP0, since “O” is stored in the request bit, the power transmission apparatus 100 does not perform the third foreign object detection process, and performs the second foreign object detection process based on the calibration curve in FIG. 21. As a result, if the power transmission apparatus 100 determines that there is a high possibility that the foreign object is absent, then in F622, the power transmission apparatus 100 transmits ACK to the power reception apparatus 101.

The authentication process (F634) performed between the power transmission apparatus 100 and the power reception apparatus 101 is now described. The authentication process is a process in which the power reception apparatus 101 authenticates the validity of the power transmission apparatus 100 (or the other way around) using an electronic certificate. Then, this process is performed by the authentication processing units 308 and 209 of the power transmission apparatus 100 and the power reception apparatus 101, respectively, and also asynchronously performed between the power reception apparatus 101 and the power transmission apparatus 100 independently of the operations in F600 to F633. More specifically, as illustrated in FIG. 6, the operations in F619 to F622 and the authentication process (F634) are performed in parallel. The authentication process is realized by the control unit 200 (the control unit 300) functioning as an authentication processing unit.

Then, if the power reception apparatus 101 confirms through the authentication process that the power transmission apparatus 100 is valid, the power reception apparatus 101 can request power greater than predetermined power (e.g., the GP is 5 watts; F609) from the power transmission apparatus 100. If the power transmission apparatus 100 confirms through the authentication process that the power reception apparatus 101 is valid, the power transmission apparatus 100 can accept, as the GP, power greater than the predetermined power (e.g., the GP is 5 watts; F609) for the power transmission apparatus 100. Further, there is a case where the power reception apparatus 101 changes the output voltage of the voltage control unit 203 depending on the magnitude of the GP. Conceivable examples of such a case include a case where, while the output voltage is 5 volts for the GP of 5 watts, the power reception apparatus 101 changes the output voltage to 9 volts for the GP exceeding 5 watts. As in the authentication process, the output voltage is asynchronously changed independently of the communication between the power transmission apparatus 100 and the power reception apparatus 101.

Referring back to FIG. 6, in F634, if the power reception apparatus 101 confirms through the authentication process that the power transmission apparatus 100 is valid, then in F623, the power reception apparatus 101 transmits a renegotiation request to the power transmission apparatus 100. In F624, the power transmission apparatus 100 transmits ACK for accepting the renegotiation request to the power reception apparatus 101.

Next, in F625, the power reception apparatus 101 transmits SRQ (GP) to request 15 watts as the GP. In F626, the power transmission apparatus 100 transmits ACK for accepting the SRQ (GP) to the power reception apparatus 101. In F627, the power reception apparatus 101 transmits SRQ (EN) as in the above described manner. In F628, the power transmission apparatus 100 transmits ACK, and the renegotiation is ended.

Suppose that in F635, the voltage control unit 203 of the power reception apparatus 101 changes the output voltage. If the output voltage is changed, the loss of the voltage control unit 203 changes, and thus the already created calibration curve is to be discarded and a calibration curve is to be newly created. In the present exemplary embodiment, this process is referred to as a “re-calibration process”.

In F629, the power transmission apparatus 100 and the power reception apparatus 101 perform the re-calibration process based on the operations in F613 to F619. In FIG. 21, a calibration data point created based on RP1 (FOD) in the re-calibration process (F629) is a point 1204. A calibration data point created based on RP2 (FOD) in the re-calibration process (F629) is a point 1205. From this point onward, the power transmission apparatus 100 performs the second foreign object detection process based on a line segment (a calibration curve) connecting the points 1204 and 1205.

If the re-calibration process is completed, then in F630, the power reception apparatus 101 transmits CE (+) to the power transmission apparatus 100 again and performs charging by increasing the output power to 5 watts or more. In F631, the power reception apparatus 101 transmits RP0 to the power transmission apparatus 100. The power transmission apparatus 100 performs the second foreign object detection process and determines that there is a high possibility that the foreign object is absent. In F632, the power transmission apparatus 100 transmits ACK to the power reception apparatus 101. In response to the charging having been completed, then in F633, the power reception apparatus 101 transmits an EPT packet for requesting the power transmission apparatus 100 to stop the transmission of power.

As described above, based on the first foreign object detection process, the second foreign object detection process, the third foreign object detection process, the authentication process, and the change in the output voltage, wireless power transmission is performed between the power transmission apparatus 100 and the power reception apparatus 101.

### (Third Foreign Object Detection Process Based on Second Q Factor Measurement Performed Multiple Times)

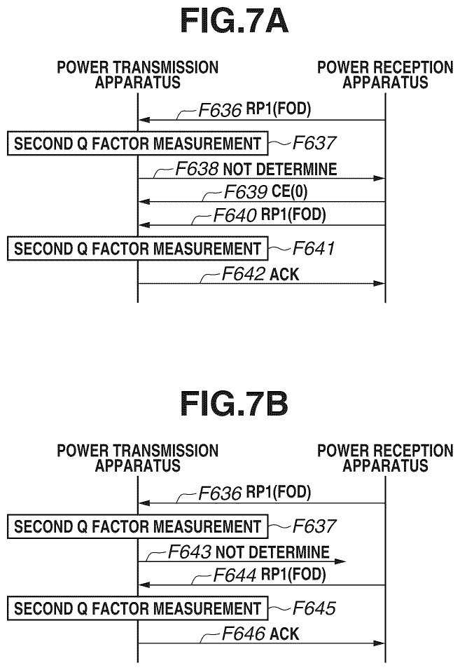

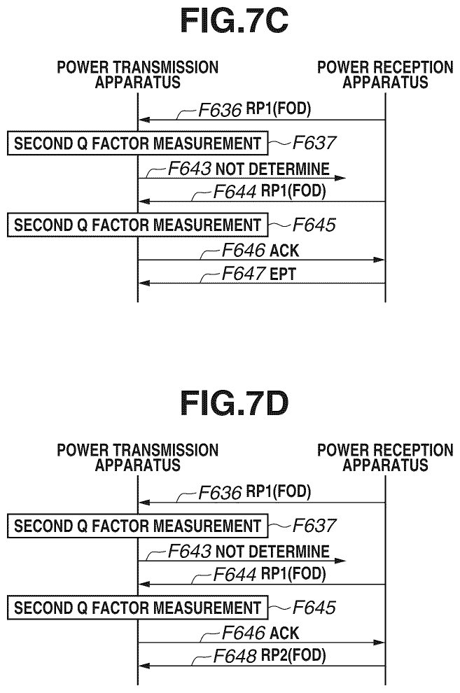

In the sequence in FIG. 6, every time the second Q factor measurement is performed once, the power transmission apparatus 100 performs the third foreign object detection process based on a result of the second Q factor measurement. There is also a case where the power transmission apparatus 100 performs the second Q factor measurement multiple times and performs the third foreign object detection process based on results of the second Q factor measurement. This process is now described with reference to FIG. 7A. In FIG. 7A, the power transmission apparatus 100 performs the second Q factor measurement twice and performs the third foreign object detection process based on the results of the second Q factor measurement. A sequence described below is processing corresponding to F613 to F615 in FIG. 6.

First, in F636, the power reception apparatus 101 transmits RP1 (FOD) to the power transmission apparatus 100. If the power transmission apparatus 100 receives the RP1 (FOD), then in F637, the power transmission apparatus 100 performs the second Q factor measurement. The second Q factor measurement (F637) performed by the power transmission apparatus 100 here is the first time of the second Q factor measurements to be performed twice. In this case, the power transmission apparatus 100 does not determine whether the calibration data included in the received RP1 (FOD) is accepted as a calibration data point. Accordingly, in F638, as a response to the RP1 (FOD) (F636), the power transmission apparatus 100 transmits to the power reception apparatus 101 a response indicating “not determine” that indicates that the power transmission apparatus 100 does not determine whether the calibration data is accepted as a calibration data point.

Next, in F639, the power reception apparatus 101 transmits CE (0) for making a request to maintain the power reception voltage to the power transmission apparatus 100. In F640, the power reception apparatus 101 transmits the RP1 (FOD) to the power transmission apparatus 100 again.

If the power transmission apparatus 100 receives the RP1 (FOD) again, then in F641, the power transmission apparatus 100 performs the second Q factor measurement again. In this case, the second Q factor measurement (F641) performed by the power transmission apparatus 100 is the second time of the second Q factor measurements to be performed twice. Suppose that the transmission power value within the period of the period T_{window} is stable, and the third foreign object detection unit 405 determines, based on the third foreign object detection, that there is a high possibility that the foreign object is absent. In this case, the power transmission apparatus 100 determines that the reception power value stored in the RP1 (FOD) and the transmission power value of the power transmission apparatus 100 when the reception power value is obtained are to be accepted as a calibration data point (corresponding to the point 1200 in FIG. 21). The transmission power value at this time is a transmission power value within the period T_{window}. In F642, the power transmission apparatus 100 transmits ACK to the power reception apparatus 101.

### (Issue Regarding Response)

Here, a description is provided of the occurrence of the missing of a response which is an issue, with reference to FIG. 7B. As described above, if the power transmission apparatus 100 performs the second Q factor measurement multiple times and performs the third foreign object detection process based on results of the second Q factor measurement, then in F643, the power transmission apparatus 100 transmits a response indicating “not determine” to an initial RP1 (FOD). However, there is a case where the power reception apparatus 101 fails to receive this response. In this case, in F644, the power reception apparatus 101 retransmits the initial RP1 (FOD).

If the power transmission apparatus 100 receives the RP1 (FOD) retransmitted in F644, then in F645, the power transmission apparatus 100 performs the second Q factor measurement. The RP1 (FOD) that the power reception apparatus 101 has retransmitted as the initial RP1 (FOD) is received as a second RP1 (FOD) by the power transmission apparatus 100. In other words, a state occurs where the recognition of the number of times of the RP1 (FOD) differs between the power reception apparatus 101 and the power transmission apparatus 100. Hereinafter, this state will be referred to as a “state mismatch”. Thus, in F645, the power transmission apparatus 100 performs a second-time second Q factor measurement among the second Q factor measurements to be performed twice. In F646, the power transmission apparatus 100 transmits ACK to the power reception apparatus 101.

The power reception apparatus 101 expects to receive a response indicating “not determine” to the initial RP1 (FOD) (F644), but receives ACK. Also in this case, the state mismatch occurs. As described above, the state mismatch that occurs once due to the missing of a response is not solved.

### (Operation of Power Reception Apparatus for Solving State Mismatch)

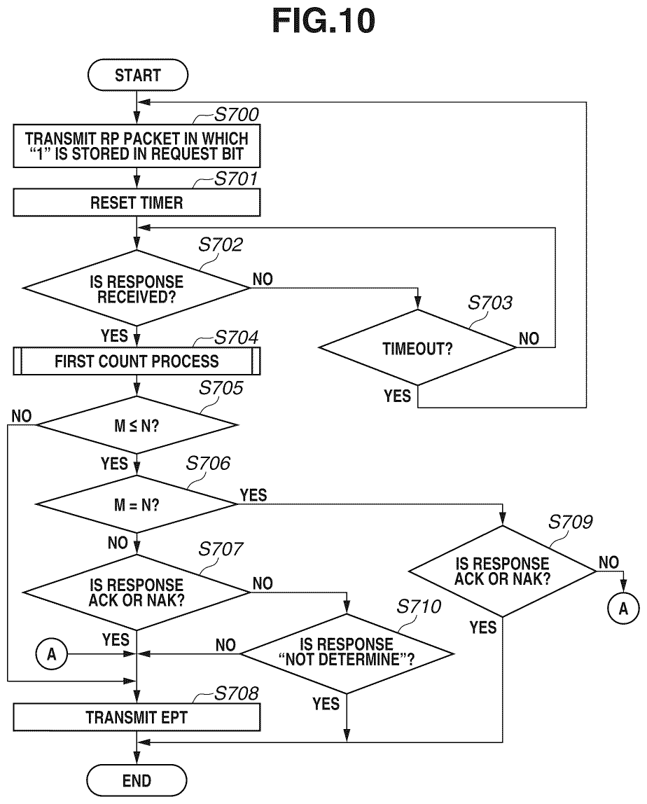

If the power reception apparatus 101 according to the present exemplary embodiment determines that the state mismatch occurs, the power reception apparatus 101 performs processing for quickly solving the state mismatch. The operation of the power reception apparatus 101 according to the present exemplary embodiment is described below with reference to FIG. 10.

FIG. 10 is a flowchart illustrating an example of a processing procedure for solving the state mismatch by the power reception apparatus 101 according to the present exemplary embodiment. Initially in step S700, the control unit 200 of the power reception apparatus 101 transmits an RP packet in which “1” is stored in the request bit (i.e., indicates RPx (FOD), x is an integer in this case) via the communication unit 204. In step S701, the control unit 200 then resets a timer for retransmission.

Next, in step S702, the control unit 200 determines whether a response to the RPx (FOD) is received via the communication unit 204. As a result of this determination, if a response to the RPx (FOD) is not received (NO in step S702), then in step S703, the control unit 200 determines whether a timeout occurs. As a result of this determination, if a timeout does not occur (NO in step S703), the processing returns to step S702. If, as a result of the determination in step S703, a timeout occurs (YES in step S703), the processing returns to step S700. In step S700, the control unit 200 retransmits the RPx (FOD). If, as a result of the determination in step S702, a response to the RPx (FOD) is received (YES in step S702), then in step S704, the control unit 200 performs a first count process.

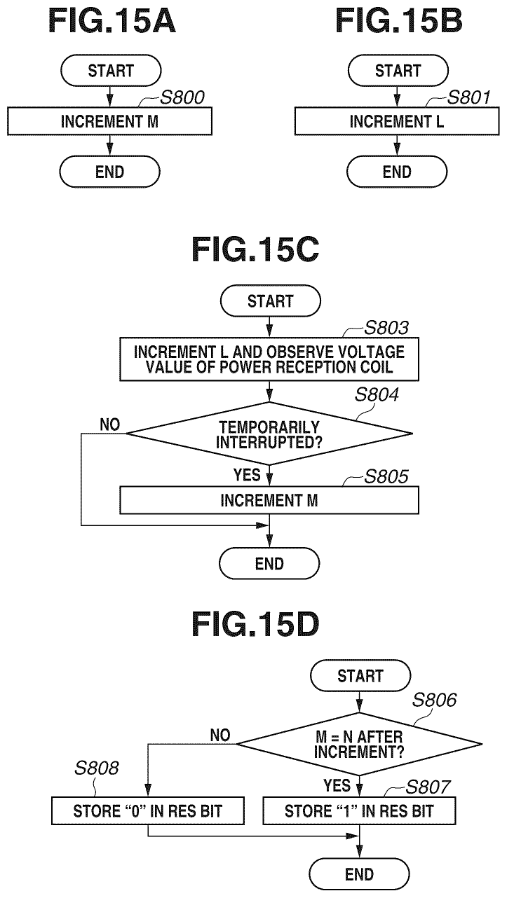

The first count process according to the present exemplary embodiment is illustrated in FIG. 15A. In step S800, the control unit 200 of the power reception apparatus 101 increments M in the first count process. M indicates the number of times the power reception apparatus 101 receives a response to the transmitted RPx (FOD) from the power transmission apparatus 100. If the power reception apparatus 101 receives a response to an initial RPx (FOD), M is one. If the power reception apparatus 101 receives a response to a second RPx (FOD), M is two. That the power transmission apparatus 100 has transmitted a response indicates that the power transmission apparatus 100 has received an M-th time PRx (FOD). In other words, the power transmission apparatus 100 grasps the number of times, among two times, the power transmission apparatus 100 receives the RPxs (FODs). The power reception apparatus 101 counts M, thus detecting the state mismatch between the power reception apparatus 101 and the power transmission apparatus 100. At the time when the power reception apparatus 101 receives a response, M is incremented by one.

Next, in step S705, the control unit 200 determines whether M is less than or equal to N. N indicates the number of times the second Q factor measurement is to be performed for the third foreign object detection process to be performed once. If the power transmission apparatus 100 performs the third foreign object detection process based on results of the second Q factor measurements performed twice, N is two. As a result of this determination, if M is less than or equal to N (YES in step S705), the processing proceeds to step S706.

In step S706, the control unit 200 further determines whether M and N are equal to each other. As a result of this determination, if M and N are not equal to each other (NO in step S706), the processing proceeds to step S707. In step S707, the control unit 200 determines whether the response received in step S702 is ACK or NAK (a negative response). As a result of this determination, if the response is not ACK or NAK (NO in step S707), then in step S710, the control unit 200 determines whether the response received in step S702 is a response indicating “not determine”. As a result of this determination, if the response is a response indicating “not determine” (YES in step S710), since this is an expected response, the processing is ended.

If, as a result of the determination in step S710, the response is not a response indicating “not determine” (NO in step S710), this indicates that the response is different from the expected response. In this case, the processing proceeds to step S708. As a result of the determination in step S707, if the response is ACK or NAK (YES in step S707), similarly, since the response is different from the expected response, the processing proceeds to step S708.

As a result of the determination in step S706, if M and N are equal to each other (YES in step S706), then in step S709, the control unit 200 determines whether the response received in step S702 is ACK or NAK indicating negative. As a result of this determination, if the response is ACK or NAK (YES in step S709), since this is an expected response, the processing is ended. If NAK is received, the power reception apparatus 101 is to perform the process of retransmitting the RPx (FOD). If, as a result of the determination in step S709, the response is not ACK or NAK (NO in step S709), similarly, since the response is different from the expected response, the processing proceeds to step S708.

In step S708, since the power reception apparatus 101 detects the state mismatch between the power reception apparatus 101 and the power transmission apparatus 100, the control unit 200 transmits EPT to the power transmission apparatus 100 via the communication unit 204, and the processing is ended. In this case, the power transmission apparatus 100 stops the transmission of power based on a request, from the power reception apparatus 101, to stop the transmission of power.

As a result of the determination in step S705, also if M is greater than N (NO in step S705), similarly, the processing proceeds to step S708. In step S708, the control unit 200 of the power reception apparatus 101 transmits EPT to the power transmission apparatus 100, and the processing is ended. The state where M is greater than N cannot normally occur, but can occur, for example, in a case where a failure occurs in the power reception apparatus 101.

With reference to FIG. 7C, processing of the operations of the power transmission apparatus 100 and the power reception apparatus 101 according to the present exemplary embodiment is described. Suppose that, as in the example of FIG. 7B, the power reception apparatus 101 fails to receive the response indicating “not determine”, and in F644, the power reception apparatus 101 retransmits an initial RP1 (FOD). Subsequently, if the power transmission apparatus 100 receives a second RP1 (FOD) (M=2) in F644, then in F646, the power transmission apparatus 100 transmits ACK to the power reception apparatus 101. The power reception apparatus 101 retransmits the initial RP1 (FOD) (M=1) in F644 and therefore expects to receive a response indicating “not determine”. However, since the power reception apparatus 101 receives an unexpected response from the power transmission apparatus 100, the state mismatch occurs. To address this, in the present exemplary embodiment, the power reception apparatus 101 transmits EPT in F647 to stop the transmission of power and returns to the initial state, thus solving the state mismatch. The power transmission apparatus 100 and the power reception apparatus 101 then transmit and receive power again based on the sequence described in conjunction with FIG. 6.

As described above, according to the present exemplary embodiment, if a response from the power transmission apparatus 100 is an unexpected response, the power reception apparatus 101 transmits EPT to the power transmission apparatus 100 to end the processing. In this manner, if the power reception apparatus 101 detects the state mismatch between the power reception apparatus 101 and the power transmission apparatus 100, the power reception apparatus 101 stops the transmission and reception of power and returns to the initial state, thus solving the state mismatch. The power reception apparatus 101 can then perform a foreign object detection process again with a proper procedure. Similarly, if M is greater than N, the power reception apparatus 101 transmits EPT to make a request to stop the transmission of power. This configuration enables prevention of the occurrence of an accident, such as smoke emission or ignition, resulting from the continuation of the transmission and reception of power despite a failure.

A second exemplary embodiment of the present disclosure will be described. In the first exemplary embodiment, a configuration has been employed in which if the power reception apparatus 101 detects the state mismatch, the power reception apparatus 101 transmits EPT, and power is transmitted and received again. In a second exemplary embodiment, a configuration is described in which if the state mismatch occurs, the power reception apparatus 101 matches the state of the power reception apparatus 101 to the state of the power transmission apparatus 100, to solve the state mismatch. The internal configurations of the power transmission apparatus 100 and the power reception apparatus 101 according to the present exemplary embodiment are similar to those according to the first exemplary embodiment. The differences from the first exemplary embodiment will be described below.

### (Operation of Power Reception Apparatus for Solving State Mismatch)

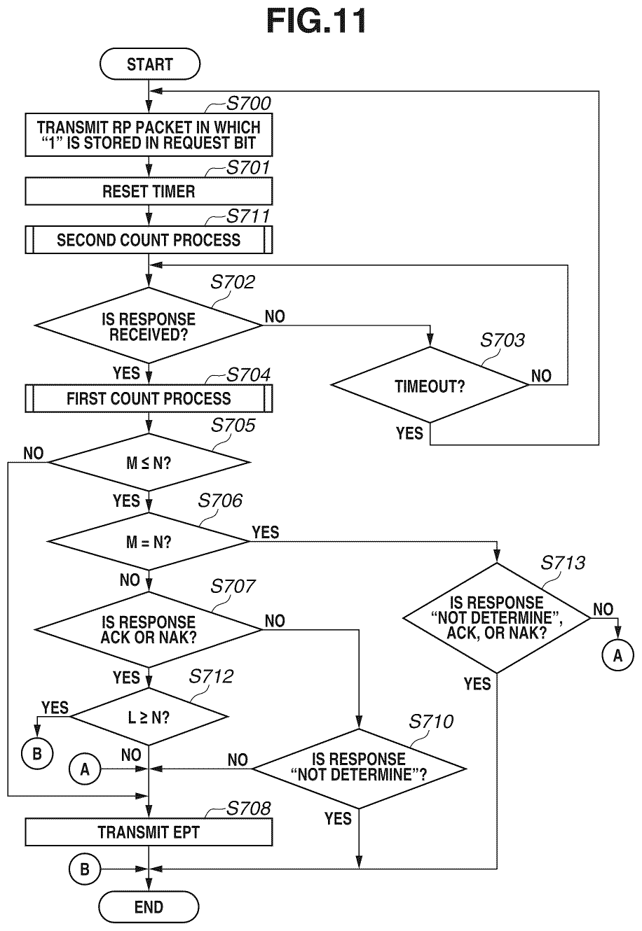

The operation of the power reception apparatus 101 for solving the state mismatch according to the present exemplary embodiment will be described with reference to FIG. 11. In the present exemplary embodiment, the power reception apparatus 101 has the function of counting the number of times the power reception apparatus 101 transmits RPx (FOD) (the number of times L) as a second count process. If the power reception apparatus 101 detects the state mismatch with the number of times L greater than or equal to N, the power reception apparatus 101 regards the power reception apparatus 101 having failed to receive a response transmitted from the power transmission apparatus 100. The power reception apparatus 101 then operates to match the state of the power reception apparatus 101 to the expected state of the power transmission apparatus 100.

FIG. 11 is a flowchart illustrating an example of a processing procedure for solving the state mismatch that is performed by the power reception apparatus 101 according to the present exemplary embodiment. Operations similar to those in FIG. 10 are designated by the same signs, and are not described in detail.

The operations in steps S700 and S701 are similar to those in FIG. 10. If the power reception apparatus 101 resets the timer, then in step S711, the control unit 200 performs a second count process. FIG. 15B illustrates the operation of the second count process. In step S801, the control unit 200 of the power reception apparatus 101 increments L in the second count process.

The operations in steps S702 to S707 are similar to those in FIG. 10. As a result of the determination in step S706, if M is equal to N (YES in step S706), the processing proceeds to step S713. As a result of the determination in step S707, if the response is ACK or NAK (YES in step S707), the processing proceeds to step S712. If the response is ACK or NAK (YES in step S707), the power reception apparatus 101 receives a response different from an expected response, and the state mismatch occurs. This, the power reception apparatus 101 determines whether the power reception apparatus 101 receives a response indicating “not determine” previously transmitted from the power transmission apparatus 100.

In step S712, the control unit 200 of the power reception apparatus 101 determines whether L is greater than or equal to N. As a result of this determination, if L is greater than or equal to N (YES in step S712), the state mismatch is regarded as occurring because the power reception apparatus 101 fails to receive a response transmitted from the power transmission apparatus 100. Further, the power reception apparatus 101 can determine that the reason why M is smaller than N is that the power reception apparatus 101 transmits RPx (FOD) L times, but fails to receive a response indicating “not determine” from the power transmission apparatus 100, and does not increment M. At this time, the power reception apparatus 101 regards the power transmission apparatus 100 as having performed the second Q factor measurements a predetermined number of times and then transmits ACK or NAK. The power reception apparatus 101 then determines that the power reception apparatus 101 receives a response indicating “not determine”. Subsequently, the power reception apparatus 101 matches the state of the power reception apparatus 101 to the state of the power transmission apparatus 100. In other words, as a result of the determination in step S712, if L is greater than or equal to N (YES in step S712), the processing is ended. After this, the power reception apparatus 101 transmits RP2 (FOD) or RP0 (FOD). If, as a result of the determination in step S712, L is less than N (NO in step S712), the processing proceeds to step S708 as in the first exemplary embodiment. If the power reception apparatus 101 receives NAK in response to the RPx (FOD), the power reception apparatus 101 performs the process of retransmitting the RPx (FOD) and other processes.

If, as a result of the determination in step S706, M and N are equal to each other (YES in step S706), then in step S713, the control unit 200 determines whether the received response is a response indicating “not determine”, ACK, or NAK. As a result of this determination, also if the response is a response indicating “not determine”, ACK, or NAK (YES in step S713), the processing is ended. If not (NO in step S713), the processing proceeds to step S708.

In the present exemplary embodiment, as a result of the determination in step S713, if the response is a response indicating “not determine” (YES in step S713), the power reception apparatus 101 operates to match the state of the power reception apparatus 101 to the state of the power transmission apparatus 100. In other words, if the power reception apparatus 101 receives a response indicating “not determine”, the power reception apparatus 101 does not transmit EPT, and transmits the RPx (FOD) again. Similarly, if the power reception apparatus 101 receives NAK, the power reception apparatus 101 performs the process of transmitting the RPx (FOD) again. If the power reception apparatus 101 receives ACK in response to the RPx (FOD), the processing is ended. After this, the power reception apparatus 101 transmits RP2 (FOD) or RP0 (FOD).

Processing of the operations of the power transmission apparatus 100 and the power reception apparatus 101 according to the present exemplary embodiment is described with reference to FIG. 7D. Suppose that, as in the example in FIG. 7B, the power reception apparatus 101 fails to receive the response indicating “not determine”, and in F644, the power reception apparatus 101 retransmits the initial RP1 (FOD). At this time, M in the first count process is 1, and L in the second count process is 2. Since M=1 at this stage, the power reception apparatus 101 expects to receive a response indicating “not determine”. In F646, however, the power reception apparatus 101 receives ACK from the power transmission apparatus 100. In this case, since L is 2 and greater than or equal to N(=2), the power reception apparatus 101 determines that the power reception apparatus 101 fails to receive the response indicating “not determine”, but the power transmission apparatus 100 performs the second Q factor measurements a predetermined number of times and then transmits ACK. Thus, the power reception apparatus 101 does not transmit EPT. Next, in F648, the power reception apparatus 101 transmits RP2 (FOD).

As described above, according to the present exemplary embodiment, if the power reception apparatus 101 detects the state mismatch, the power reception apparatus 101 operates to match the state of the power reception apparatus 101 to the state of the power transmission apparatus 100. This solves the state mismatch more efficiently while minimizing the stop of the transmission and reception of power and perform a foreign object detection process with a proper procedure.

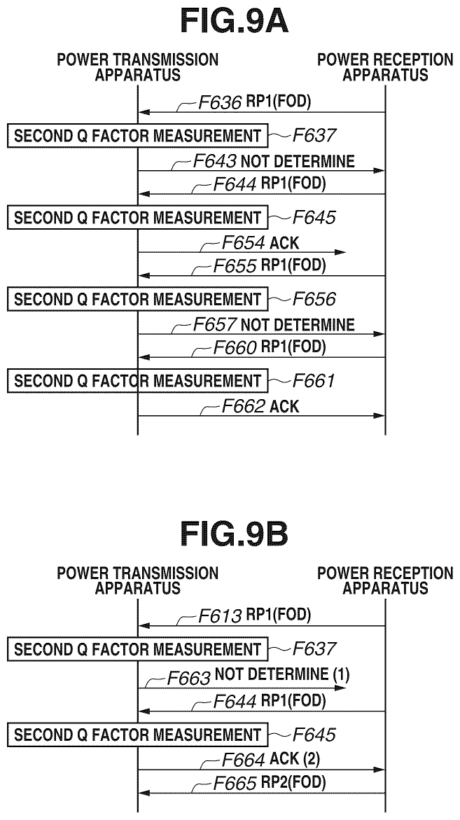

Although a case has been described where the power reception apparatus 101 fails to receive a response indicating “not determine” in the present exemplary embodiment, a similar effect can be produced also in a case where the power reception apparatus 101 fails to receive the ACK in F646. Processing of operations in this case is described with reference to FIG. 9A. Suppose that the power reception apparatus 101 fails to receive the ACK, and in F655, the power reception apparatus 101 retransmits the second RP1 (FOD). Since the power transmission apparatus 100 has already transmitted the ACK in response to the second RP1 (FOD), then in F657, the power transmission apparatus 100 transmits a response indicating “not determine” in response to the second RP1 (FOD) received in F655.

In step S706 in FIG. 11, the power reception apparatus 101 determines that M and N are equal to each other. Thus, the processing proceeds to step S713. The power reception apparatus 101 then expects to receive ACK or NAK in response to the RP1 (FOD) transmitted in F655, but finds that the state mismatch occurs at the time when the power reception apparatus 101 receives the response indicating “not determine” in F657. Further, the power reception apparatus 101 also finds that the cause of the occurrence of the state mismatch lies in a fact that the power reception apparatus 101 fails to receive the ACK in F654 and the state where the power transmission apparatus 100 is to transmit the response indicating “not determine” (i.e., the power transmission apparatus 100 receives the initial RPx (FOD)).

Accordingly, to match the state of the power reception apparatus 101 to the state of the power transmission apparatus 100, in F660, the power reception apparatus 101 does not transmit EPT, and retransmits the RP1 (FOD) to receive ACK or NAK as a response. This enables the power transmission apparatus 100 to perform the second Q factor measurement in F661. In F662, the power transmission apparatus 100 transmits ACK.

Alternatively, if the power reception apparatus 101 detects the state mismatch, the power reception apparatus 101 may continue to transmit RPx (FOD) that is kept being transmitted at the time of detection of the state mismatch, until the power reception apparatus 101 receives ACK or NAK.

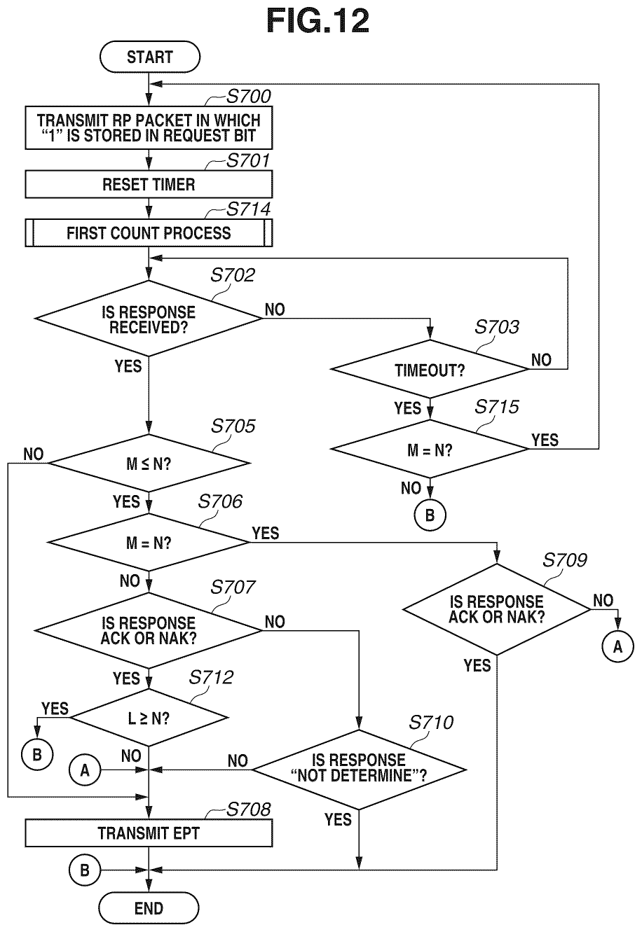

A third exemplary embodiment of the present disclosure will be described. The power reception apparatus 101 according to a third exemplary embodiment observes the voltage value of the power reception coil 201 to determine the state of the power transmission apparatus 100 and operates to match the state of the power reception apparatus 101 to the state of the power transmission apparatus 100. The operation of the power reception apparatus 101 according to the present exemplary embodiment is described with reference to FIG. 12. The internal configurations of the power transmission apparatus 100 and the power reception apparatus 101 according to the present exemplary embodiment are similar to those according to the first exemplary embodiment. The differences from the first and second exemplary embodiments are described below.

FIG. 12 is a flowchart illustrating an example of a processing procedure for solving the state mismatch by the power reception apparatus 101 according to the present exemplary embodiment. Processes similar to those in FIG. 10 or 11 are designated by the same signs, and are not described in detail.

Operations in Steps S700 and S701 are similar to those in FIG. 10. If the power reception apparatus 101 resets the timer, then in step S714, the control unit 200 of the power reception apparatus 101 performs a first count process. FIG. 15C illustrates the first count process according to the present exemplary embodiment.

FIG. 15C is a flowchart illustrating an example of the detailed procedure of the first count process in step S714 in FIG. 12.

Initially in step S803, the control unit 200 of the power reception apparatus 101 increments L and observes the voltage value of the power reception coil 201. In step S804, as a result of observing the voltage value, the control unit 200 determines whether the transmission of power is temporarily interrupted. The voltage value of the power reception coil 201 when the power transmission apparatus 100 performs the second Q factor measurement has a waveform that indicates that the transmission of power has been temporarily interrupted as illustrated in FIG. 20B. As a result of the determination in step S804, if the control unit 200 determines that the transmission of power is temporarily interrupted (YES in step S804), then in step S805, the control unit 200 increments M. If the control unit 200 determines that the transmission of power is not temporarily interrupted (NO in step S804), the control unit 200 does not increment M, and the processing is ended.

The operations in steps S702 and S703 are similar to those in FIG. 10. As a result of the determination in step S703, if a timeout occurs (YES in step S703), the processing proceeds to step S715. In step S715, the control unit 200 determines whether M and N are equal to each other. As a result of this determination, if M and N are not equal to each other (NO in step S715), the processing is immediately ended. If M and N are equal to each other (YES in step S715), the processing returns to step S700.

Next, a description will be provide of the processing of the power transmission apparatus 100 and the power reception apparatus 101 according to the present exemplary embodiment with reference to FIG. 7D. The power reception apparatus 101 detects that the power transmission apparatus 100 temporarily interrupts the transmission of power for the second Q factor measurement that is performed for the first time in F637. M is incremented at this stage. Subsequently, even if the power reception apparatus 101 fails to receive a response (a response indicating “not determine”) in step S702 and a timeout occurs (YES in step S703), since M=1 whereas N=2, it is determined in step S715 that M and N are not equal to each other. As described above, even if the power reception apparatus 101 fails to receive a response indicating “not determine”, the power reception apparatus 101 is regarded as having received the response. Next, in F644, the power reception apparatus 101 can transmit a second RP1 (FOD).

As described above, according to the present exemplary embodiment, the power reception apparatus 101 observes the voltage value of the power reception coil 201, thus grasping the number of times the power transmission apparatus 100 has performed the second Q factor measurements. This prevents the occurrence of the state mismatch efficiently while minimizing the stop of the transmission and reception of power and perform a foreign object detection process through a proper procedure.

A fourth exemplary embodiment of the present disclosure will be described below. A configuration is described in which the power reception apparatus 101 according to the present exemplary embodiment notifies the power transmission apparatus 100 of the number of times M of receptions of responses currently grasped by the power reception apparatus 101, thus avoiding the state mismatch. The internal configurations of the power transmission apparatus 100 and the power reception apparatus 101 according to the present exemplary embodiment are similar to those according to the first exemplary embodiment. The differences from the first and second exemplary embodiments are described below.

### (Operation of Power Reception Apparatus According to Present Exemplary Embodiment)

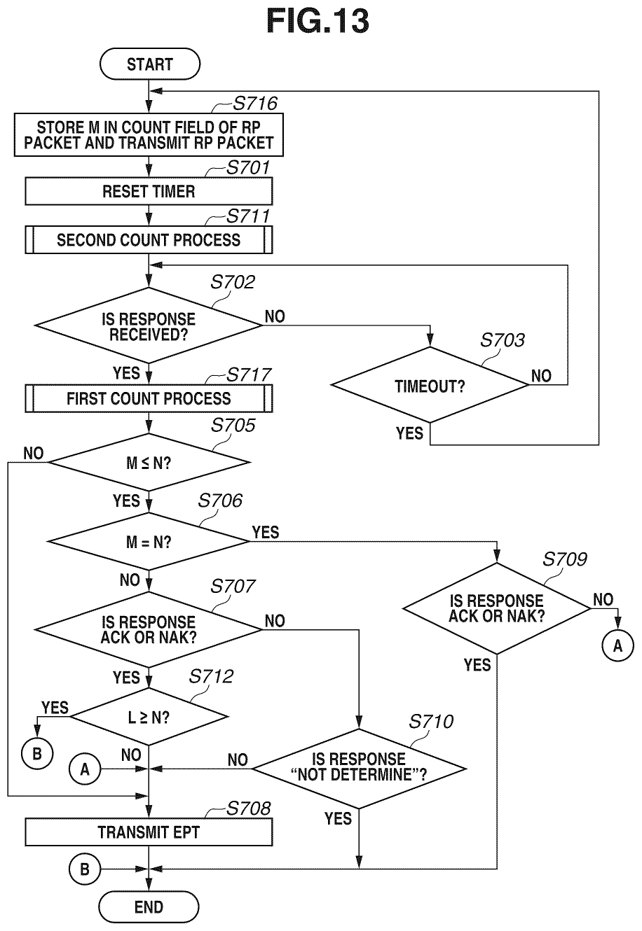

The operation of the power reception apparatus 101 according to the present exemplary embodiment is initially described with reference to FIG. 13. FIG. 13 is a flowchart illustrating an example of a processing procedure for solving the state mismatch by the power reception apparatus 101 according to the present exemplary embodiment. Processes similar to those in FIG. 10 or 11 are designated by the same signs, and are not described in detail.

Initially in step S716, the control unit 200 of the power reception apparatus 101 stores information regarding the number of times M of receptions of responses in a count field of an RPx (FOD) packet and transmits the RPx (FOD) packet to the power transmission apparatus 100.

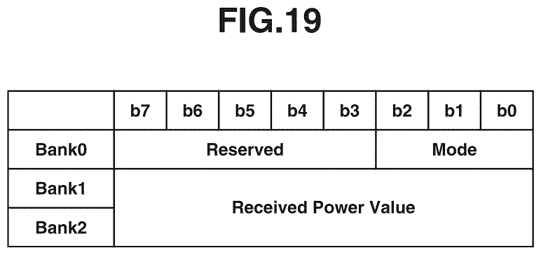

FIG. 19 is a diagram illustrating the format of a received power packet in the WPC standard. As illustrated in FIG. 19, bits 3 to 7 of “Bank 0” are reserved areas. The power reception apparatus 101 according to the present exemplary embodiment stores information regarding the number of times M of receptions of responses into the bits 6 and 7 of “Bank 0”. In step S717, the control unit 200 increments M as illustrated in FIG. 15A.

### (Operation of Power Transmission Apparatus According to Present Exemplary Embodiment)

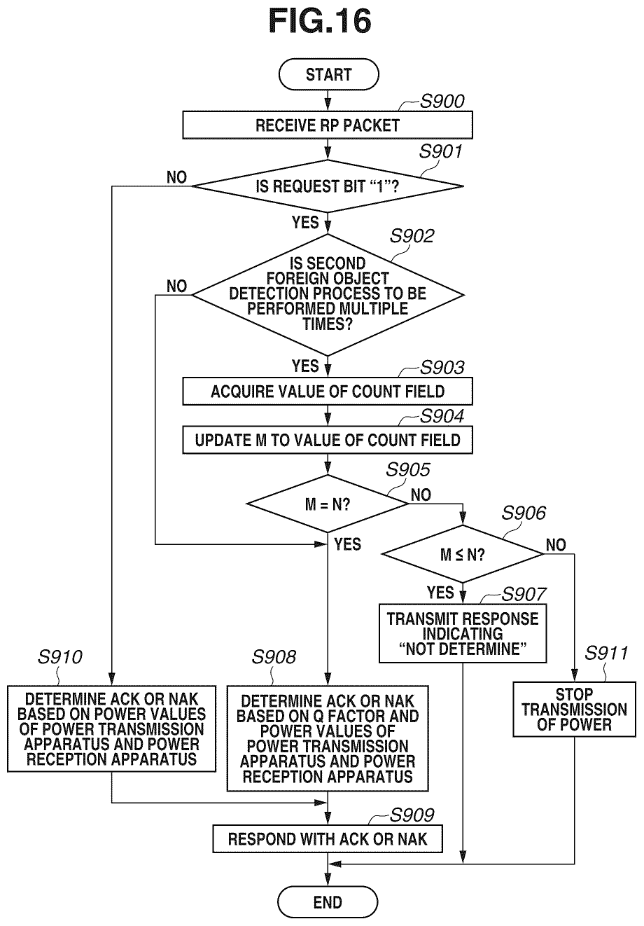

Next, the operation of the power transmission apparatus 100 according to the present exemplary embodiment is described with reference to FIG. 16. FIG. 16 is a flowchart illustrating an example of a processing procedure in a case where the power transmission apparatus 100 receives an RPx (FOD) packet that stores information regarding the number of times M of reception of a response.

Initially in step S900, the control unit 300 of the power transmission apparatus 100 receives a received power packet from the power reception apparatus 101 via the communication unit 304. In step S901, the control unit 300 determines whether the request bit stored in the packet is one. As a result of this determination, if the request bit is one (YES in step S901), the processing proceeds to step S902.

In step S902, the control unit 300 determines whether to perform the second foreign object detection process multiple times. As a result of this determination, if the second foreign object detection process is to be performed multiple times (YES in step S902), the processing proceeds to step S903. If not (NO in step S902), the processing proceeds to step S908.

In step S903, the control unit 300 acquires the value of the count field of the received power packet. In step S904, the control unit 300 updates the number of times M of transmissions of responses managed by the control unit 300 to the acquired value of the count field.

Next, in step S905, the control unit 300 of the power transmission apparatus 100 determines whether M and N are equal to each other. As a result of this determination, if M and N are equal to each other (YES in step S905), then in step S908, based on the Q factor measured by the second Q factor measurement and the power values of the power transmission apparatus 100 and the power reception apparatus 101, the control unit 300 determines which of ACK and NAK is to be transmitted. In step S909, the control unit 300 responds with ACK or NAK to the power reception apparatus 101 via the communication unit 304.

If, as a result of the determination in step S905, M and N are not equal to each other (NO in step S905), then in step S906, the control unit 300 determines whether M is smaller than N. As a result of this determination, if M is smaller than N (YES in step S906), then in step S907, the control unit 300 of the power transmission apparatus 100 makes a response indicating “not determine” via the communication unit 304. If M is greater than N (NO in step S906), then in step S911, the control unit 300 of the power transmission apparatus 100 stops the transmission of power. The situation where M is greater than N cannot normally occur, but can occur if the power reception apparatus 101 breaks down.

If, as a result of the determination in step S901, the request bit is not “1” (NO in step S901), the second Q factor measurement unit 401 does not perform the Q factor measurement. Thus, in step S910, the control unit 300 determines, based on the power values of the power transmission apparatus 100 and the power reception apparatus 101, which of ACK and NAK is to be transmitted. The processing then proceeds to step S909.

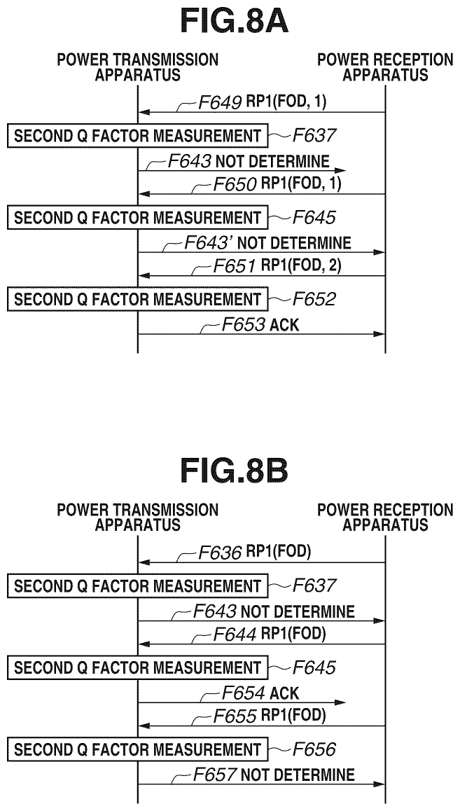

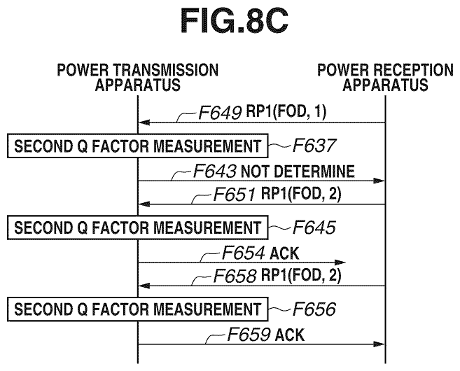

Next, the operations of the power transmission apparatus 100 and the power reception apparatus 101 according to the present exemplary embodiment is described with reference to FIG. 8A. Suppose that, initially in F649, the power reception apparatus 101 transmits RP1 (FOD, 1) in which “1” indicating the first time is stored in the count field to the power transmission apparatus 100. The power reception apparatus 101 fails to receive a response indicating “not determine” (F643) transmitted from the power transmission apparatus 100. In this case, in F650, the power reception apparatus 101 transmits the RP1 (FOD, 1) again.

The power transmission apparatus 100 refers to the count field of the received RP1 (FOD, 1), thus recognizing the mismatch of the number of times M and grasping that the power transmission apparatus 100 is to make a response indicating “not determine”. Thus, in F643′, the power transmission apparatus 100 transmits a response indicating “not determine” in this case. Next, if the power reception apparatus 101 receives the response indicating “not determine”, then in F651, the power reception apparatus 101 transmits RP1 (FOD, 2) indicating the second time. Since the number of times M in the count field of the received RP1 (FOD, 2) is two, then in F653, the power transmission apparatus 100 responds with ACK.

A case is described where the power reception apparatus 101 fails to receive ACK or NAK with reference to FIG. 8B. As illustrated in FIG. 8B, in F654, if the power reception apparatus 101 fails to receive the ACK transmitted from the power transmission apparatus 100, then in F655, the power reception apparatus 101 retransmits the RP1 (FOD) to cause the power transmission apparatus 100 to transmit ACK or NAK. However, since the power transmission apparatus 100 has already transmitted the ACK, then in F657, the power transmission apparatus 100 transmits a response indicating “not determine”. Also in such a case, the state mismatch occurs.

FIG. 8C illustrates operations of the power transmission apparatus 100 and the power reception apparatus 101 according to the present exemplary embodiment in a case where the power reception apparatus 101 fails to receive ACK or NAK. As illustrated in FIG. 8C, in F654, if the power reception apparatus 101 fails to receive the ACK transmitted from the power transmission apparatus 100, the power reception apparatus 101 retransmits the received power packet to cause the power transmission apparatus 100 to transmit ACK or NAK. At this time, in F658, the power reception apparatus 101 retransmits the RP1 (FOD, 2) in which the number of times M of receptions in the count field is two. If the power transmission apparatus 100 receives the RP1 (FOD, 2), the power transmission apparatus 100 finds that the power reception apparatus 101 requests ACK or NAK as a response. Thus, in F659, the power transmission apparatus 100 transmits ACK.

As described above, according to the present exemplary embodiment, a configuration has been employed in which the power reception apparatus 101 stores information regarding the state of the power reception apparatus 101 (the number of times M of reception of a response) in the count field of RPx (FOD) and transmits the RPx (FOD), and the power transmission apparatus 100 determines the operation of the power transmission apparatus 100 based on the count field. This configuration efficiently prevents the occurrence of the state mismatch while minimizing the stop of the transmission and reception of power and enables a foreign object detection process to be performed through a proper procedure.

### (Variation of Fourth Exemplary Embodiment)

A fourth exemplary embodiment of the present disclosure will be described below. While the power reception apparatus 101 according to the present exemplary embodiment stores information regarding the number of times M of receptions grasped by the power reception apparatus 101 in the count field of RPx (FOD) and transmits the RPx (FOD), other configurations may be employed. Specifically, the power reception apparatus 101 stores an information element meaning that the power reception apparatus 101 requests ACK or NAK as a response in any of the bits 3 to 7 as the reserved areas of “Bank 0” in an RPx (FOD) packet. In the present exemplary embodiment, hereinafter, the information element will be referred to as a “RES bit”. If the power reception apparatus 101 requests ACK or NAK as a response, the power reception apparatus 101 stores “1” in the RES bit. If not, the power reception apparatus 101 stores “O” in the RES bit.

The basic processing of the power reception apparatus 101 is similar to that in FIG. 13, except that in step S716, the control unit 200 stores information indicating “0” or “1” in the RES bit instead of storing the information regarding the number of times M of receptions.

FIG. 15D is a flowchart illustrating an example of a processing procedure for determining the numerical value of the RES bit in a packet to be transmitted in step S716 according to a variation of the present exemplary embodiment.

Initially in step S806, the control unit 200 of the power reception apparatus 101 determines whether M and N are equal to each other in a case where M is incremented next. As a result of this determination, if M and N are equal to each other (YES in step S806), the power reception apparatus 101 expects ACK or NAK as a response. Thus, in step S807, the control unit 200 stores “1” in the RES bit. If M and N are not equal to each other (NO in step S806), the power reception apparatus 101 expects a response indicating “not determine”. Thus, in step S808, the control unit 200 stores “O” in the RES bit.

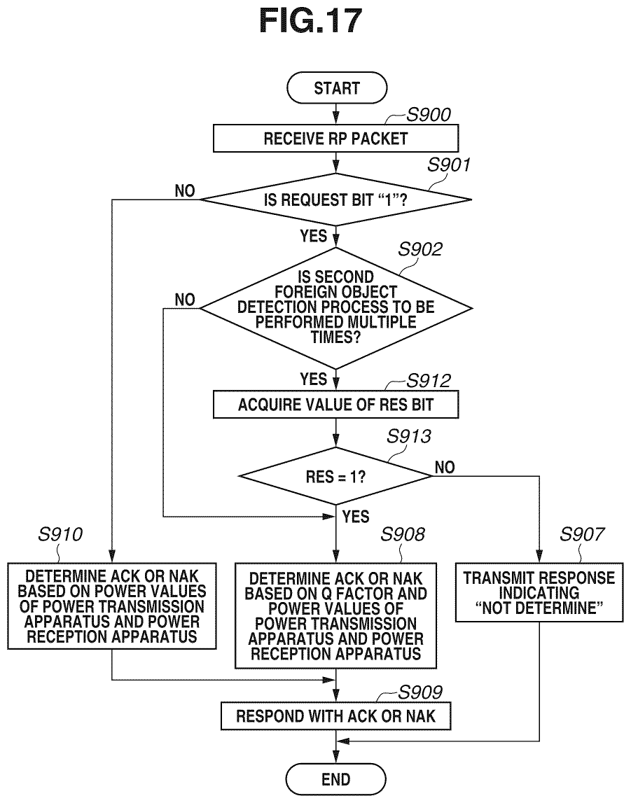

Next, the operation of the power transmission apparatus 100 according to the variation of the present exemplary embodiment will be described with reference to FIG. 17. FIG. 17 is a flowchart illustrating an example of a processing procedure in a case where the power transmission apparatus 100 receives an RPx (FOD) packet including the RES bit. Processes similar to those in FIG. 16 are designated by the same signs, and are not described in detail.

Operations in steps S900 to S902 are similar to those in FIG. 16. In step S912, the control unit 300 of the power transmission apparatus 100 acquires the value of the RES bit. In step S913, the control unit 300 determines whether RES=1. As a result of this determination, if RES=1 (YES in step S913), the processing proceeds to step S908 so that the power transmission apparatus 100 complies with the request from the RES bit. If RES=0 (NO in step S913), the processing proceeds to step S907 so that the power transmission apparatus 100 complies with the request from the RES bit. The configuration as described above prevents the occurrence of the state mismatch.

In FIG. 8C, also in a case where the RES bit is used, a similar effect can be produced by the power reception apparatus 101 retransmitting RP1 (FOD, RES=1) in which “1” is stored in the RES bit in F658.

A fifth exemplary embodiment of the present disclosure will be described below. In the fourth exemplary embodiment, the power reception apparatus 101 stores the state of the power reception apparatus 101 in a received power packet and transmits the received power packet. In the fifth exemplary embodiment, a configuration is described in which the power transmission apparatus 100 transmits the state of the power transmission apparatus 100 when making a response. The internal configurations of the power transmission apparatus 100 and the power reception apparatus 101 according to the present exemplary embodiment are similar to those according to the first exemplary embodiment. The differences from the fourth exemplary embodiment are described below.

### (Operation of Power Transmission Apparatus 100 According to Present Exemplary Embodiment)

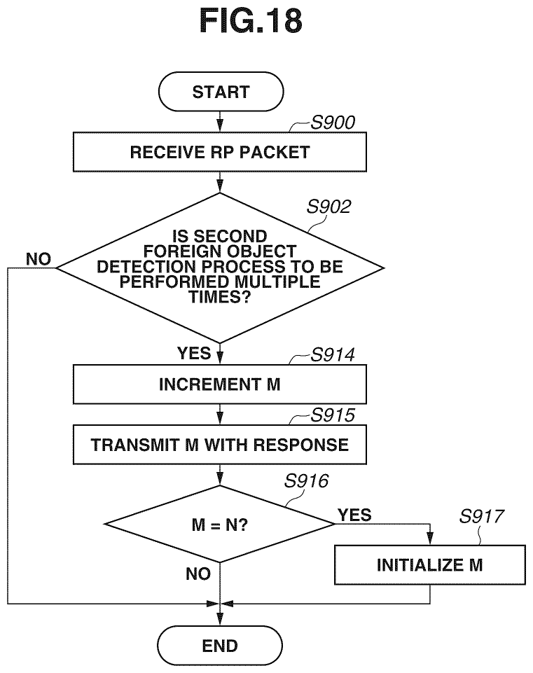

With reference to FIG. 18, the operation of the power transmission apparatus 100 according to the present exemplary embodiment is described. FIG. 18 is a flowchart illustrating an example of a processing procedure of the power transmission apparatus 100 in a case where the power transmission apparatus 100 receives a received power packet according to the present exemplary embodiment.

Initially in step S900, the control unit 300 of the power transmission apparatus 100 receives a received power packet from the power reception apparatus 101 via the communication unit 304. In step S902, the control unit 300 determines whether to perform the second foreign object detection process multiple times. As a result of this determination, if the second foreign object detection process is to be performed multiple times (YES in step S902), the processing proceeds to step S914. If not (NO in step S902), the processing is ended.

In step S914, the control unit 300 increments the number of times M of transmissions of responses. In step S915, the control unit 300 transmits information regarding the number of times M of transmissions with a response to the power reception apparatus 101 via the communication unit 304. Next, in step S916, the control unit 300 determines whether M and N are equal to each other. If, as a result of this determination, M and N are not equal to each other (NO in step S916), the processing is immediately ended. If M and N are equal to each other (YES in step S916), then in step S917, the control unit 300 initializes M to zero, and the processing is ended.

### (Operation of Power Reception Apparatus 101 According to Present Exemplary Embodiment)

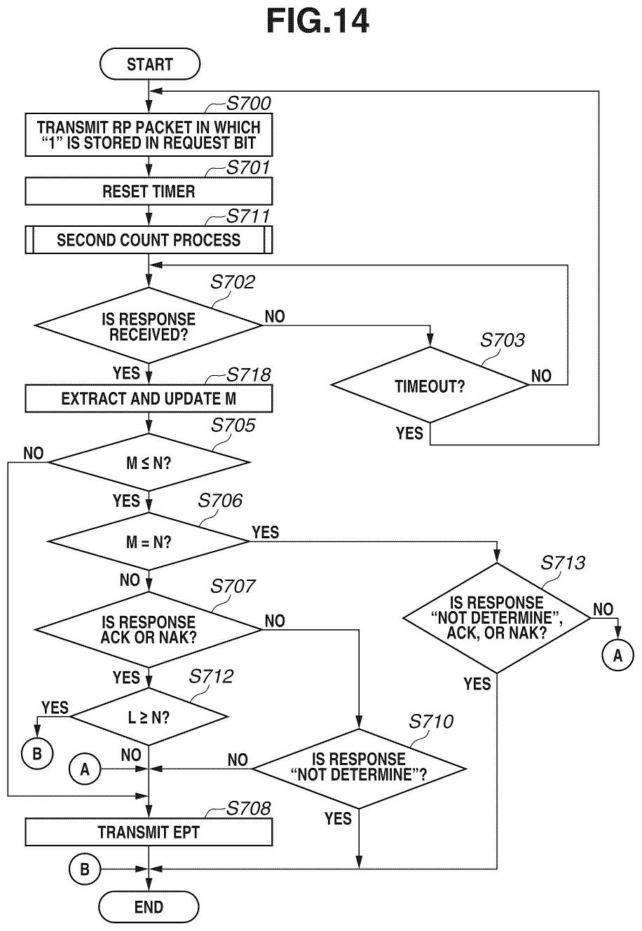

The operation of the power reception apparatus 101 according to the present exemplary embodiment is described with reference to FIG. 14. FIG. 14 is a flowchart illustrating an example of a processing procedure for solving the state mismatch by the power reception apparatus 101 according to the present exemplary embodiment. Processes similar to those in FIGS. 11 to 13 are designated by the same signs, and are not described in detail.

The operations in steps S700 to S703 and S711 are similar to those in FIG. 11. If the power reception apparatus 101 receives a response (YES in step S702), the processing proceeds to step S718. In step S718, the control unit 200 extracts information regarding the number of times M of transmissions from the response from the power transmission apparatus 100 and updates the extracted information as the number of times M of receptions. The operations in step S705 and the subsequent steps are similar to those in FIGS. 12 and 13.

Next, the operations of the power transmission apparatus 100 and the power reception apparatus 101 according to the present exemplary embodiment is described with reference to FIG. 9B. In F663, the power transmission apparatus 100 transmits a response indicating “not determine (1)” that indicates the current value of M (one in this case) with a response indicating “not determine” as a response to the RP1 (FOD). If the power reception apparatus 101 fails to receive this response, then in F644, the power reception apparatus 101 retransmits the RP1 (FOD). Since the power transmission apparatus 100 has transmitted the response indicating “not determine (1)”, then in F664, the power transmission apparatus 100 transmits ACK (2) obtained by adding the value of M to ACK as a response to the power reception apparatus 101. If the power reception apparatus 101 receives the ACK (2), then in F665, the power reception apparatus 101 updates the number of times M of receptions, thus recognizing that the ACK is a correct response. Then, the power reception apparatus 101 transmits next RP2 (FOD).

As described above, according to the present exemplary embodiment, the power transmission apparatus 100 stores information regarding the number of times M of transmissions (the number of times M of receptions) in a response from the power transmission apparatus 100. Thus, the state mismatch is prevented efficiently while minimizing the stop of the transmission and reception of power and a foreign object detection process is performable through a proper procedure.

### Other Exemplary Embodiments

Although in the description of the first to fifth exemplary embodiments, the number of times N the power transmission apparatus 100 performs the second Q factor measurements for the third foreign object detection process to be performed once is two, it is clear that N may be three or more times. The above exemplary embodiments do not limit the scope of the disclosure. While a plurality of features is described in the exemplary embodiments, not all the plurality of features is essential for carrying out the exemplary embodiments, and the plurality of features may be optionally combined together.

The present disclosure can also be implemented by the process of supplying a program for achieving one or more functions of the above exemplary embodiments to a system or an apparatus via a network or a storage medium, and of causing one or more processors of a computer of the system or the apparatus to read and execute the program. The present disclosure can also be achieved by a circuit (e.g., an application-specific integrated circuit (ASIC)) for achieving the one or more functions.

At least parts of the flowcharts illustrated in FIGS. 10 to 18 may be implemented by hardware. In a case where parts of the flowcharts are implemented by hardware, for example, a dedicated circuit may be automatically generated on a field-programmable gate array (FPGA) according to a program for achieving steps, using a predetermined compiler. “FPGA” is the abbreviation for field-programmable gate array. Alternatively, a gate array circuit may be formed similarly to the FPGA and achieved as hardware.

Each of the power reception apparatus 101 and the power transmission apparatus 100 can have the function of executing applications other than a wireless charging application. An example of the power reception apparatus 101 is an information processing terminal, such as a smartphone. An example of the power transmission apparatus 100 is an accessory device for charging the information processing terminal. For example, the information terminal device includes a display unit (a display) to which power received from a power reception coil (antenna) is supplied and which displays information to a user. The power received from the power reception coil is stored in a power storage unit (a battery), and the battery supplies the power to the display unit. In this case, the power reception apparatus 101 may include a communication unit that communicates with another apparatus different from the power transmission apparatus 100. The communication unit may be compatible with a communication standard such as near-field communication (NFC) communication or the fifth generation mobile communication system (5G). In this case, the communication unit may perform communication by the battery supplying the power to the communication unit. Alternatively, the power reception apparatus 101 may be a tablet terminal or a storage device such as a hard disk device or a memory device, or may be an information processing apparatus such as a personal computer (PC). Yet alternatively, for example, the power reception apparatus 101 may be an imaging apparatus (a camera or a video camera). Yet alternatively, the power reception apparatus 101 may be an image input apparatus such as a scanner, or may be an image output apparatus such as a printer, a copying machine, or a projector. Yet alternatively, the power reception apparatus 101 may be a robot or a medical device. The power transmission apparatus 100 can be an apparatus for charging the above devices.

Yet alternatively, the power transmission apparatus 100 may be a smartphone. In this case, the power reception apparatus 101 may be another smartphone, or may be wireless earphones.

Yet alternatively, the power reception apparatus 101 according to the present exemplary embodiment may be a vehicle such as an automobile. For example, the automobile as the power reception apparatus 101 may receive power from a charger (the power transmission apparatus 100) via a power transmission antenna installed in a parking lot. Alternatively, the automobile as the power reception apparatus 101 may receive power from a charger (the power transmission apparatus 100) via a power transmission coil (antenna) embedded in a road. Power received by such an automobile is supplied to a battery. The power in the battery may be supplied to a motor unit (a motor or an electric-powered unit) that drives wheels, or may be used to drive a sensor used in driving assistance or drive a communication unit that communicates with an external apparatus. That is, in this case, the power reception apparatus 101 may include the wheels, the battery, the motor or the sensor driven using received power, and further, a communication unit that communicates with an apparatus other than the power transmission apparatus 100. Further, the power reception apparatus 101 may include an accommodation unit that accommodates a person. Examples of the sensor include a sensor used to measure the distance between vehicles or the distance from another obstacle. For example, the communication unit may be compatible with the Global Positioning System (Global Positioning Satellite, GPS). The communication unit may also be compatible with a communication standard such as 5G. Alternatively, the vehicle may be a bicycle or an automatic motorcycle. Alternatively, the power reception apparatus 101 is not limited to a vehicle, and may be a moving object or a flying object including a motor unit driven using power stored in a battery.

Yet alternatively, the power reception apparatus 101 according to the present exemplary embodiment may be a power tool or a household electrical appliance product. Each of these devices as the power reception apparatus 101 may include a battery and a motor driven by received power stored in the battery. Each of these devices may also include a notification unit that gives a notification of the remaining amount of the battery. Each of these devices may also include a communication unit that communicates with another apparatus different from the power transmission apparatus 100. The communication unit may be compatible with a communication standard such as NFC or 5G.

The power transmission apparatus 100 according to the present exemplary embodiment may be an in-vehicle charger that transmits power to a mobile information terminal device, such as a smartphone or a tablet compatible with wireless power transmission, inside an automobile. Such an in-vehicle charger may be provided anywhere in the automobile. For example, the in-vehicle charger may be installed in the console of the automobile, or may be installed in the instrument panel (the instrument panel or the dashboard), at a position between seats for passengers, on the ceiling, or on a door. The in-vehicle charger, however, is to be prevented from being installed at a location where the in-vehicle charger interferes with driving. Although an example has been described where the power transmission apparatus 100 is an in-vehicle charger, such a charger is not limited to a charger placed in a vehicle, and may be installed in a transport vehicle such as a train, an aircraft, or a vessel. The charger in this case may also be installed at a position between seats for passengers, on the ceiling, or on a door.

Alternatively, a vehicle, such as an automobile including an in-vehicle charger, may be the power transmission apparatus 100. In this case, the power transmission apparatus 100 includes wheels and a battery and supplies power to the power reception apparatus 101 via a power transmission circuit unit and a power transmission coil (antenna) using power in the battery.

The present disclosure is not limited to the above exemplary embodiments, and can be changed and modified in various ways without departing from the spirit and the scope of the present disclosure. Thus, the following claims are appended to publicize the scope of the present disclosure.

According to the present disclosure, it is possible to perform an appropriate process in the determination of the presence or absence of an object different from a power transmission apparatus and a power reception apparatus based on Q factor measurements performed multiple times.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A power reception apparatus comprising:
a power reception unit configured to wirelessly receive power from a power transmission apparatus; and
a communication unit configured to transmit a first request to the power transmission apparatus, configured to receive from the power transmission apparatus a response for the first request, and configured to transmit a second request for stopping a power transfer to the power transmission apparatus based on the received response.

2. The power reception apparatus according to claim 1, wherein the communication unit transmits the second request in a case where the received response does not correspond to the number of times of receptions.

3. The power reception apparatus according to claim 2, wherein, in a case where the received response is based on a result of a foreign object detection process performed by the power transmission apparatus and corresponds to the number of times of the first request, the communication unit does not transmit the second request.

4. The power reception apparatus according to claim 3, wherein, in a case where the received response is not based on the result of the foreign object detection process and does not correspond to the number of times of receptions, the communication unit does not transmit the second request t, and transmits, to the power transmission apparatus, a third request to transmit a response that is based on the result of the foreign object detection process.

5. The power reception apparatus according to claim 1, further comprising a detection unit configured to detect temporary interruption of the transmission of power from the power transmission apparatus,
wherein, in a case where the received response corresponds to the number of times of the temporary interruption, the communication unit does not transmit the second request.

6. The power reception apparatus according to claim 1, wherein the first request includes information regarding the number of times of the received responses.

7. The power reception apparatus according to claim 1, wherein the first request includes information regarding a response for a request of the power reception apparatus.

8. The power reception apparatus according to claim 1,
wherein the communication unit receives the response for the first request, including information regarding the number of times of responses of the power transmission apparatus, and
wherein, in a case where the received response does not correspond to the number of times of the responses included in the received response, the communication unit transmit the second request.

9. A method for a power reception apparatus, the method comprising:
transmitting a first request to the power transmission apparatus;
receiving from the power transmission apparatus a response for the first request; and
transmitting a second request for stopping a power transfer to the power transmission apparatus based on the received response.

10. A non-transitory computer-readable storage medium storing a program for causing a computer to perform a method for a power reception apparatus, the method comprising:
transmitting a first request to the power transmission apparatus;
receiving from the power transmission apparatus a response for the first request; and
transmitting a second request for stopping a power transfer to the power transmission apparatus based on the received response.
